(19) United States
(12) Patent Application Publication
(10) Pub. No.: US 2014/0237263 A1
(43) Pub. Date: Aug. 21, 2014

(54) NONVOLATILE SEMICONDUCTOR MEMORY DEVICE AND MEMORY SYSTEM USING THE SAME

(71) Applicant: Kabushiki Kaisha Toshiba, Minato-ku (JP)

(72) Inventors: Toshihiro SUZUKI, Tokyo (JP); Yuji Nagai, Sagamihara-shi (JP); Noboru Shibata, Kawasaki-shi (JP)

(73) Assignee: Kabushiki Kaisha Toshiba, Minato-ku (JP)

(21) Appl. No.: 13/965,515

(22) Filed: Aug. 13, 2013

Related U.S. Application Data
(60) Provisional application No. 61/766,477, filed on Feb. 19, 2013.

(51) Int. Cl. G06F 12/14

(52) U.S. Cl. CPC G06F 12/1408
USPC 713/193

(57) ABSTRACT

According to one embodiment, a nonvolatile semiconductor memory device includes a memory cell array and an encryption arithmetic module. The memory cell array includes a first storage area and a second storage area. The first storage area is inhibited from being written into and read from and stores secret key data. The second storage area is inhibited from being written into and permitted to be read from and stores encrypted key data and an expected value. The encryption arithmetic module carries out an authentication operation based on the secret key data and message data. The expected value is the result of carrying out the authentication operation.

### CROSS-REFERENCE TO RELATED APPLICATIONS

This application claims the benefit of U.S. Provisional Application No. 61/766,477, filed Feb. 19, 2013, the entire contents of which are incorporated herein by reference.

### FIELD

Embodiments described herein relate generally to a nonvolatile semiconductor memory device, such as a security system of a NAND flash memory, and a memory system using the nonvolatile semiconductor memory device.

### BACKGROUND

For example, in a security system where a host device authenticates a NAND flash memory, an encryption arithmetic circuit mounted on a NAND flash memory carries out an operation on the basis of one of a plurality of secret keys stored in a chip and a random number output by the host device and supplies the operation result to the host device. The host device compares the operation result with a predetermined expected value for authentication.

However, after a NAND flash memory has been shipped, if the authentication has failed because of an acquired cause, it is difficult to identify the cause of the defect.

### BRIEF DESCRIPTION OF THE DRAWINGS

FIG. 1 shows the relationship between a NAND chip provided with an encryption arithmetic circuit according to a first embodiment and a host device;

FIG. 2 shows the relationship between data types stored in a ROM area and a hidden area in the NAND chip and slots;

FIG. 3 is a flowchart to explain an example of the process of manufacturing a NAND chip;

FIG. 4 shows pages in the ROM area and the allocation of internal data;

FIG. 5 shows an example of a command sequence for reading an authentication expected value;

FIG. 6 is a block diagram schematically showing a basic configuration of the NAND chip shown in FIG. 1;

FIG. 7 shows an example of a memory cell array shown in FIG. 6;

FIG. 8 is a circuit diagram of one of a plurality of memory blocks shown in FIG. 7;

FIG. 9 is a block diagram schematically showing a basic configuration of a page buffer and its peripheral circuitry according to the first embodiment;

FIG. 10 is a circuit diagram schematically showing an example of the page buffer and its peripheral circuitry according to the first embodiment;

FIG. 11 is a more concrete circuit diagram showing an example of the page buffer and its peripheral circuitry according to the first embodiment;

FIG. 12A is a schematic diagram showing a basic configuration of a page buffer according to the first embodiment, FIG. 12B is a schematic diagram showing a case where areas are allocated to the page buffer of the first embodiment by function, FIG. 12C is a schematic diagram showing a more detailed allocation of the page buffer according to the first embodiment, and FIG. 12D is a schematic diagram showing an allocation of the page buffer according to the first embodiment;

FIG. 13 is a block diagram showing an example of an AES encryption circuit according to the first embodiment;

FIG. 14 is a block diagram showing an example of an AES encryption arithmetic device according to the first embodiment;

FIG. 15 is a sequence chart showing an example of an AES encryption sequence according to the first embodiment;

FIG. 16 is a block diagram schematically showing an example of testing a NAND chip with a test device;

FIG. 17 is a flowchart to explain an example of a test sequence for a NAND chip according to a second embodiment;

FIG. 18 shows an example of a command sequence corresponding to the test sequence shown in FIG. 17;

FIG. 19 shows a test sequence of the NAND chip;

FIG. 20 shows a test sequence following FIG. 19;

FIG. 21 shows a test sequence following FIG. 20;

FIG. 22 shows a test sequence following FIG. 21;

FIG. 23 shows a test sequence following FIG. 22;

FIG. 24 shows a test sequence following FIG. 23;

FIG. 25 shows an example of a hidden area applied to the first and second embodiments;

FIG. 26 shows another example of a hidden area applied to the first and second embodiments;

FIG. 27 shows still another example of a hidden area applied to the first and second embodiments;

FIG. 28 is a block diagram of a secret key data write system applied to the first and second embodiments;

FIG. 29 is a block diagram showing an example of an address control circuit 123 applied to the first and second embodiments; and

FIG. 30 is a flowchart to explain a data erasing sequence in a NAND chip 10 according to the first and second embodiments.

### DETAILED DESCRIPTION

In general, according to one embodiment, a nonvolatile semiconductor memory device includes a memory cell array and an encryption arithmetic module. The memory cell array includes a first storage area and a second storage area. The first storage area is inhibited from being written into and read from and stores secret key data. The second storage area is inhibited from being written into and permitted to be read from and stores encrypted key data and an expected value. The encryption arithmetic module carries out an authentication operation based on the secret key data stored in the first storage area and message data externally supplied. The expected value stored in the second storage area is the result of carrying out the authentication operation on the secret key data based on a specific message.

A system where a host device, such as a video reproducer, authenticates a NAND flash memory provided with an encryption arithmetic circuit has been proposed.

When an encryption arithmetic circuit is mounted on the NAND flash memory, it is important to suppress an increase in the chip area to reduce costs. In addition, when secret key data is recorded in a flash memory cells, it is necessary to take the characteristic of the memory cells into account.

When an encryption arithmetic circuit conforming to the Advanced Encryption Standard (AES) (hereinafter, referred to as an AES arithmetic circuit) is mounted on a NAND flash memory chip, a method of miniaturizing the chip by causing the AES arithmetic circuit to use a page buffer previously mounted on the NAND flash memory as a storage device (RAM) has been proposed. The AES arithmetic circuit carries out an AES operation on the basis of secret key data and message (random number) data from outside the chip in an authentication operation and outputs the result as an authentication operation result to outside the chip.

Suppose authentication has failed after shipment, that is, the failure of the authentication operation result to coincide with an expected value has occurred. In the case of a method of storing a secret key in a NAND flash memory, it is conceivable that the chances are high the cause of the failure is a defect in key data stored in the NAND flash memory. The reason is that the defect rate of increasingly miniaturized memory cell may be higher than that of transistors in a peripheral circuit used for authentication operations.

At this time, the most likely defect mode is that an acquired defect has occurred in the secret key data stored in the memory cell due to a read disturb defect or a data retention defect. As a result of this defect, the result of the authentication operation based on the secret key data differs from the expected value.

“Read disturb,” which is a data changing error mode, means that the quantity of electrons in the floating gate changes as a result of reading the same page or an adjacent page repeatedly.

“Data retention,” which is a data changing error mode, means that data changes as a result of electrons held in the floating gate escaping from there because the written page has been left as it is for a long time.

In addition, as a means to prevent a defect in key data, a technique has been developed in which several sets of key data items are prepared as complementary pairs to prevent a problem from occurring even if acquired defects have occurred in some of the pairs. However, even this technique cannot reduce the possibility of acquired defects to zero.

With this backdrop, when a defect failing to pass authentication due to an acquired cause has occurred after the shipment of a NAND flash memory, the embodiment makes it possible to determine which one of a plurality of key data items stored in the chip has contributed to the defect. To achieve this, an authentication expected value for each key data item is recorded in a special format into an authentication function block provided in the NAND flash memory in advance in the manufacturing processes before shipment. If a defect has occurred, the authentication expected value is read from the defective chip authentication function block, making it easier to determine the cause of the defect.

Hereinafter, embodiments will be explained with reference to the accompanying drawings.

### First Embodiment

In a first embodiment, an expected value stored in a NAND flash memory acting as a nonvolatile semiconductor memory device is read into a tester and an authentication operation result obtained by actually carrying out an authentication operation is read in to the tester, thereby causing the tester to compare the expected value and the authentication operation result.

<Schematic Configuration of Memory System>

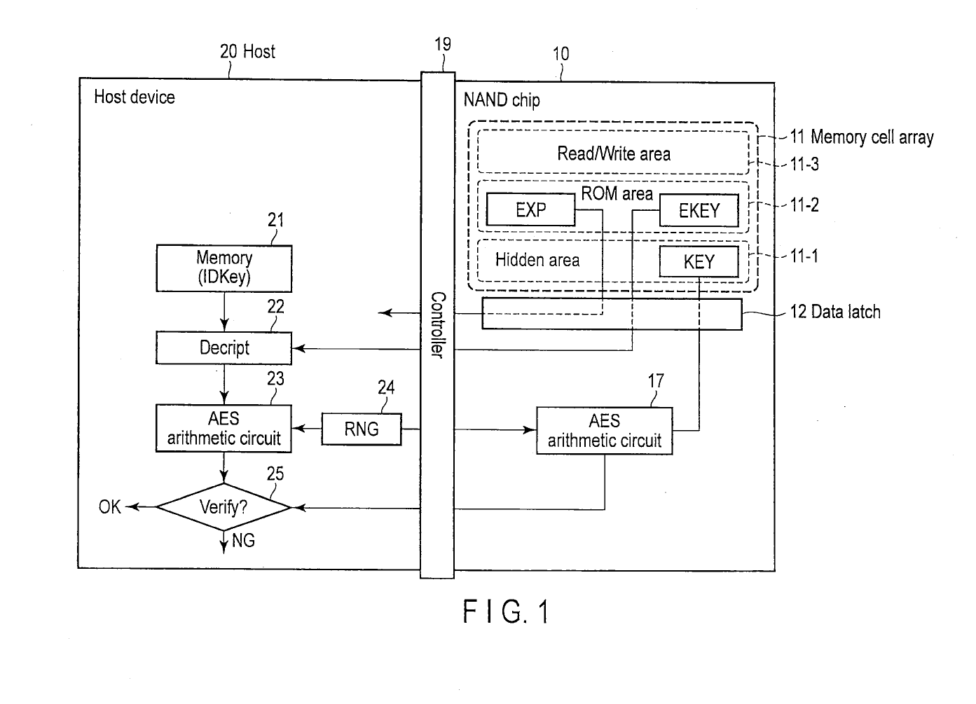

The configuration of a memory system according to the first embodiment will be explained with reference to FIG. 1.

As shown in FIG. 1, the memory system comprises a NAND chip 10 acting as an authenticated device including a NAND flash memory, a host device 20 acting as an authentication device (e.g., a video reproducer), and a controller 19 serving as an intermediary between the NAND chip 10 and the host device 20. The host device 20 accesses the NAND chip 10 via the controller 19.

Here, the processes of manufacturing a semiconductor product, such as a NAND chip 10, will be explained briefly. The processes of manufacturing a semiconductor product can be divided into a pre-process of forming a circuit on a substrate wafer and a post-process of segmenting the wafer into pieces, installing wiring, and sealing a resin package.

The controller 19 is configured variously as follows: it is configured so as to be included in the NAND chip 10 in the pre-process, it is configured so as not to be included in the NAND chip in the pre-process, but so as to be included in the same package, and it is configured to be provided as a chip differing from the NAND chip 10. Hereinafter, an explanation will be given, taking, as an example, a case where the controller 19 is provided as a chip differing from the NAND chip 10, with reference to the accompanying drawings including FIG. 1.

Hereinafter, unless otherwise stated, data and instructions are mostly exchanged between the host device 20 and the NAND chip 10 through the assistance of the controller 19. In this case, too, the controller 19 does not change essential contents of the data and instructions and therefore a detailed explanation of the controller 19 will be omitted. An example of the configuration of the NAND chip 10 and controller 19 will be described in detail later.

In addition, it is conceivable that the host device 20 is composed of special hardware as a consumer device is, of a combination of special hardware and firmware that causes the hardware to operate, or of software that causes all the functions of the device to operate on a personal computer. Even if the host device 20 employs any configuration, the embodiment is basically applicable to the host device 20.

1-1. NAND Chip

The NAND chip 10 according to the first embodiment comprises a memory cell array 11, a data latch 12 arranged in an area peripheral to the cell array 11, and an AES arithmetic circuit 17 serving as an authentication circuit.

The memory cell array 11 is divided into a first to a third storage area according to the confidential level of stored data.

The first storage area, which is a hidden area 11-1, is inhibited from being externally read from, written into, or erased from. In the hidden area 11-1, a plurality of secret key data items KEYs serving as secret keys used by the NAND chip 10 in an authentication process are recorded. The secret key data items KEYs cannot be read to the outside, but can be read at the time of authentication operations in the NAND chip 10.

The second storage area, which is a ROM area 11-2, is inhibited from being externally written into, but permitted to be read from or erased from.

In the ROM area 11-2, key data encrypted on the basis of key data hidden by the host device 20 (hereinafter, referred to as encrypted key data EKEY) is recorded. Since the encrypted key data EKEY has been recorded in the ROM area 11-2, it can be externally read. However, since the encrypted key data EKEY has been encrypted on the basis of the key data hidden by the host device 20, even if the key data EKEY has been read from the outside, the authentication system will not be cracked unless the secret key data KEY has been leaked.

The ROM area 11-2 may be, for example, an One Time Program (OTP) area in which writing is permitted only once or an area which is an ordinary area that can be read from and written into in the process of manufacturing a NAND chip 10 and which is turned into a read-only area by rewriting a management flag after shipment. Alternatively, a write command for the area may be a special command differing from a command for an ordinary area. In this method, the special command is not provided to a receiver of the NAND chip 10. Furthermore, the ROM area 11-2 may be configured to be treated as an ordinary area on the NAND chip 10 and limit the functions the controller 19 provides for the host device 20 to a reading one.

The third storage area, which is an ordinary read/write area 11-3, is permitted to be externally read from and written into.

The AES arithmetic circuit 17 is an AES encryption device. To realize an AES function, not only the AES arithmetic circuit 17 but also a key storage device and a RAM are needed. The key storage device is a hidden area 11-1 of the NAND chip 10. A data latch (page buffer) 12 is used as a RAM.

In an authentication operation, the AES arithmetic circuit 17 reads key data KEY from the hidden area 11-2 and carries out an authentication operation using the key data KEY and a message (random number) supplied via the controller 19 from a random number generator 24 of the host device 20. The operation result is supplied via the controller 19 to the host device 20.

Although not shown, an output module that outputs data to the host device 20 from the NAND chip 10 via the controller 19 is actually arranged as a component.

1-2. Host Device

In the first embodiment, the host device 20 is an authentication device, such as a tester that detects a defect in a computer or a NAND chip 10 described later.

The host device 20 comprises, for example, a memory 21, a decrypt module 22, an AES arithmetic circuit 23, a random number generator (RNG) 24, and a data verify module 25.

The memory 21 has stored, for example, an identification key IDKey. The identification key IDKey is key data previously hidden by the host device 20. The key data EKEY stored in the ROM area 11-2 is encrypted on the basis of the identification key IDKey.

The decrypt module 22 decrypts the encrypted key data EKEY supplied from the NAND chip 10 via the controller 19 using the identification key IDKey read from the memory 21 and outputs the decrypted key data.

The AES arithmetic circuit 23 carries out an authentication operation using key data supplied from the decrypt module 22 and a random number (message) supplied from the random number generator 24.

The data verify module 25 compares the operation result supplied from the AES arithmetic circuit 23 with the operation result supplied from the AES arithmetic circuit 17 of the NAND chip 10. If the comparison result has shown that both the operation results coincide with each other, the data verify module 25 outputs a signal or data indicating that authentication has passed. If the comparison result has shown that both the operation results do not coincide with each other, the data verify module 25 outputs a signal or data indicating that authentication has failed.

The host device 20 reads an expected value EXP from the ROM area 11-2 of the NAND chip 10 via the controller 19 when checking the secret key data KEY stored in the hidden area 11-1 of the NAND chip 10 for a defect as described later. The read expected value EXP is stored in, for example, the memory 21. The expected value EXP may be stored not only in the memory 21 but also in another memory (not shown).

The controller 19 secures a part of the read/write area 11-3 and stores control data necessary for its own operation there. The controller 19 may have the function of converting a logical address received from the host device 20 into a physical address of the NAND chip 10. In addition, the controller 19 may has the function of performing wear leveling to level the fatigue of the memory cell array 11, provided that at least the hidden area 11-1 is not subjected to wear leveling.

The memory system is not limited to the above configuration. For example, the memory system may be provided with another component, such as an error correction module (not shown), as needed.

<Memory Cell Array>

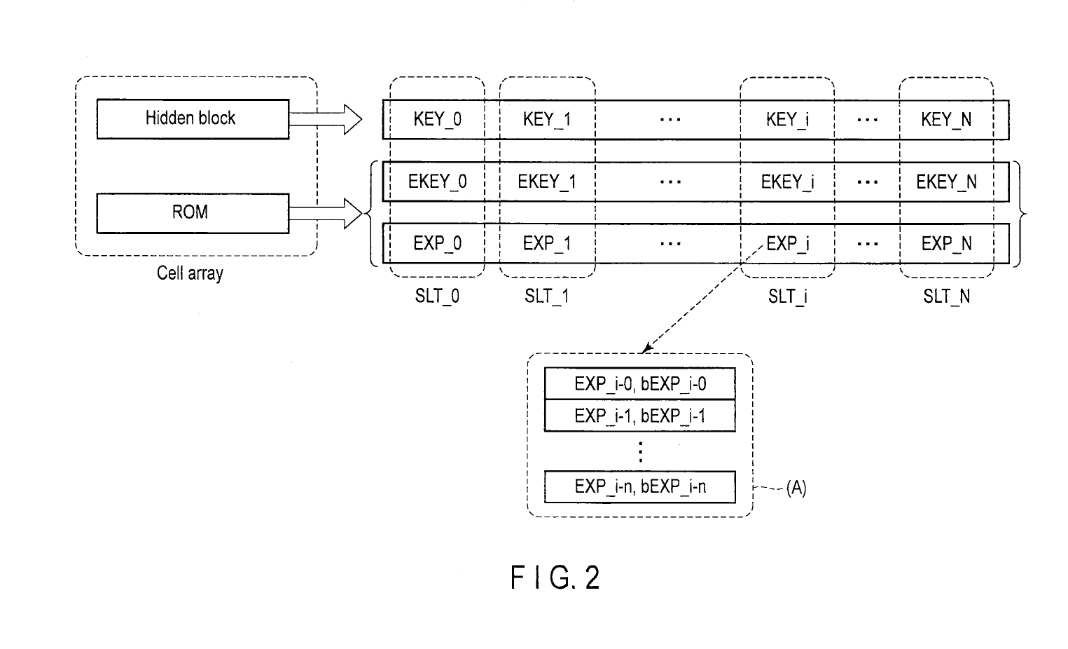

FIG. 2 shows an example of the configuration of the hidden area 11-1 and ROM area 11-2 of the memory cell array 11. In the hidden area 11-1, a plurality of secret key data items KEY_0, . . . , KEY_N have been stored. In the ROM area 11-2, not only have a plurality of encrypted key data items EKEY_0, . . . EKEY_N been stored, but also expected values EXP_0, . . . , EXP_N have been stored so as to correspond to the encrypted key data items EKEY_0, . . . , EKEY_N, respectively.

In the hidden area 11-1 and ROM area 11-2, a plurality of slots SLT_0, SLT_1, . . . , SLT_i, . . . , SLT_N have been set. These slots SLT_0, . . . , SLT_N are caused to correspond to, for example, applications the user uses. Each of the slots SLT_0, . . . , SLT_N includes secret key data, encrypted key data, and an expected value. For example, the slot SLT_0 is composed of secret key data KEY_0, encrypted key data EKEY_0, and an expected value EXP_0.

Here, in an AES encryption method, even if an expected value in an authentication operation on a secret key data item has been known, it is impossible to determine, from the expected value, the secret key data item that is an input value of the authentication operation. Therefore, the expected values EXP_0, . . . , EXP_N can be stored in the ROM area 11-2. In the first embodiment, it is assumed that there is no defect in the expected values stored in the ROM area 11-2.

The AES arithmetic circuit 17 of the NAND chip 10 carries out an authentication operation (hereinafter, sometimes just referred to as an operation) conforming to the AES standard expressed by the following equation using a message (random number) supplied from the host device 20 via the controller 19 and secret key data KEY read from the hidden area 11-1 and outputs the operation result:

R=AES (m, k(i))

R: Result; operation result

m: Message; message

k: KEY; secret key data

i: slot number

The secret key data KEY is supposed to be written by the manufacturer of the NAND chip 10 or a card vendor in manufacturing the NAND chip 10. The manufacturer of the NAND chip 10 gives the NAND chip 10 in which the secret key data KEY has been written to the card vendor.

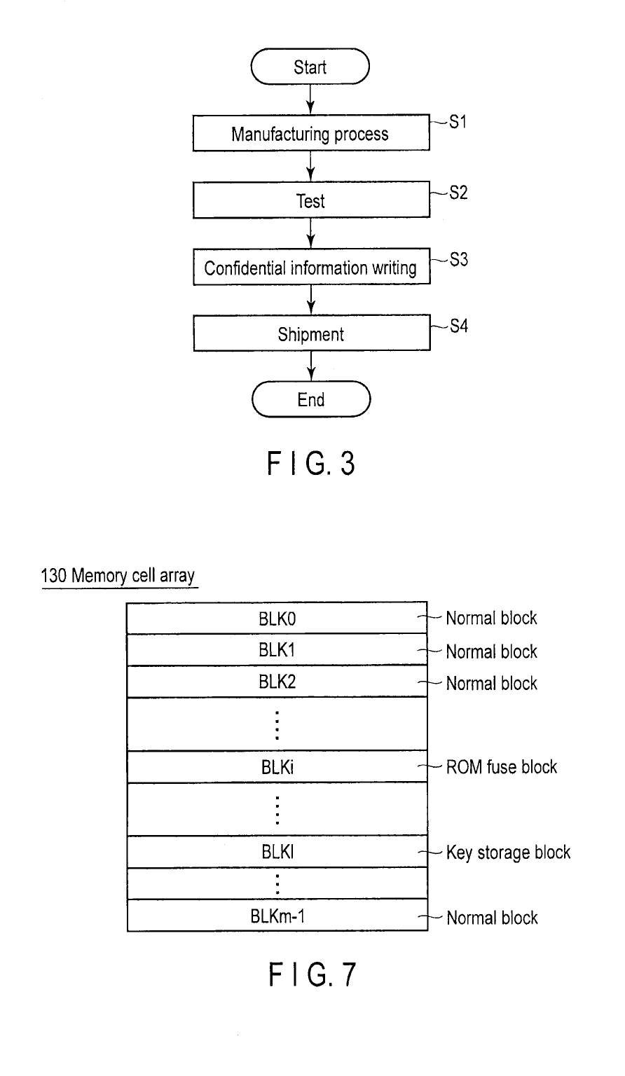

FIG. 3 is a flowchart to explain an example of the processes ranging from the manufacture to shipment of the NAND chip 10, a semiconductor memory device. As shown in FIG. 3, a NAND chip 10 is manufactured (step S1). Next, the NAND chip 10 is tested (step S2). After the test has been completed in step S2, secret key data KEY is written into the hidden area 11-1 and encrypted key data EKEY and an expected value EXP are written into the ROM area 11-2 (step S3). These write operations are carried out by, for example, the tester. Thereafter, the NAND chip 10 is shipped (step S4). The hidden area 11-1 can be written into before the writing of the secret key data KEY and is inhibited from being written into, read from, or erased from after the writing of the secret data KEY.

As described above, the memory cell array 11 is provided with a plurality of slots as data sets for storing key data. The host device 20 selects any one of the slots to carry out an actual operation.

Specifically, a slot number is given to each of the slots. The host device 20 informs the NAND chip 10 of information corresponding to the selected slot number. The AES arithmetic circuit 17 of the NAND chip 10 reads secret key data KEY from the hidden area 11-1 on the basis of the information corresponding to the informed slot number and caries out an authentication process.

Here, if message data is, for example, “FFh,” let the result of an operation conforming to the AES standard be an expected value EXP. That is, the expected value EXP is defined by the following equation:

EXP=AES(“FFh”,k(i))

One operation result is determined, depending only on the secret key data KEY.

In the process of writing encrypted key data EKEY, an expected value EXP corresponding to each of the encrypted key data items EKEYs is written in the ROM area 11-2. At this time, to improve the reliability, the expected value EXP is written in the form of a plurality of sets in complementary form.

The expected value EXP cannot be written into a general-purpose readable/writable area 11-3. The reason is that the general-purpose readable/writable area 11-3 might be erased from. Recording an expected value EXP in complementary form makes it possible to increase the reliability.

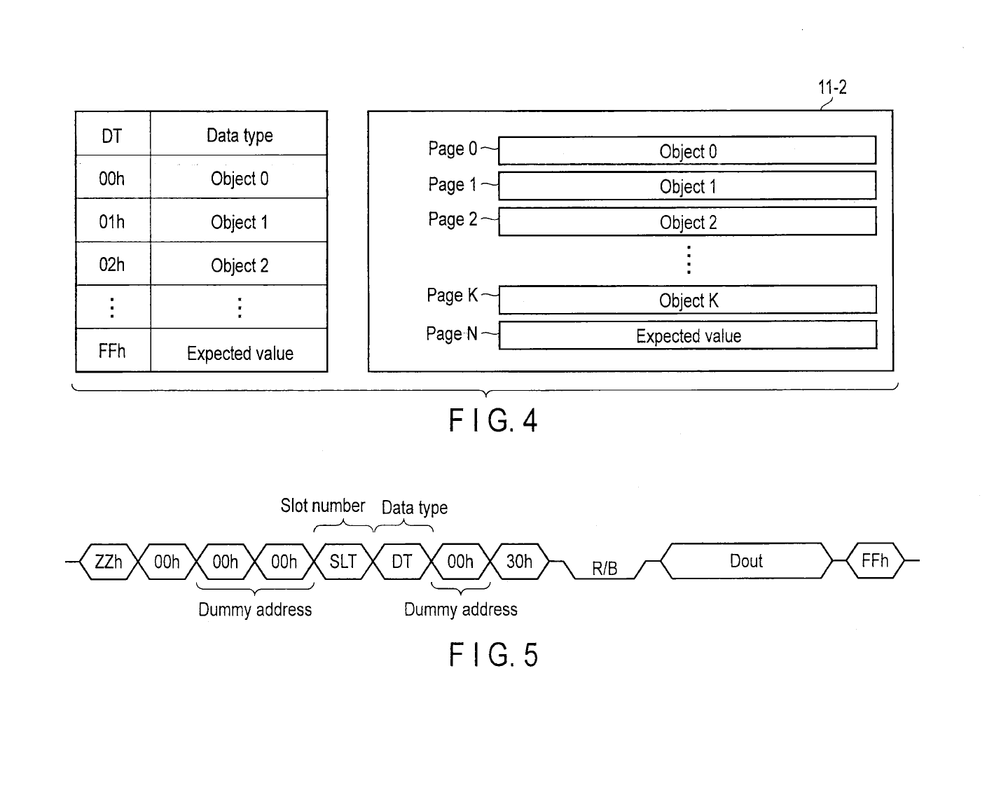

FIG. 4 shows pages in the ROM area 11-2 and the allocation of internal data items. “DT” indicates data type. When “DT” is “00h,” it indicates “object 0.” When “DT” is “01h,” it indicates “object 1.” When “DT” is “02h,” it indicates “object 2.” The same holds true for the rest. When “DT” is “FFh,” it indicates an “expected value” in authentication. In the ROM area 11-2, for example, “object 0” is stored on page 0, “object 1” is stored on page 1, “object 2” is stored on page 2, . . . , “object k” is stored on page k, and an “expected value” in authentication on page N.

(Expected Value Read Sequence)

FIG. 5 shows a case where, for example, the host device 20 reads data from the ROM area 11-2, for example, a command sequence in reading an expected value. The expected value is read in determining which secret key KEY has caused an authentication failure when the authentication failure has occurred in the NAND chip 10.

In FIG. 5, the host device 20 continues issuing a read command “00h” after a command “ZZh.” Then, the host device 20 issues addresses over five cycles. In the five cycles, the first two cycles and a fifth cycle correspond to dummy addresses. In a third cycle, information corresponding to a slot number is issued. In a fourth cycle, “FFh” is issued as data type “DT.” After this, a read executable command “30h” is issued.

In response to the executable command “30h,” the NAND chip 10 brings a ready/busy signal R/B into a ready state, causing an expected value to be read from the ROM area 11-2. When, for example, “00h,” “01h,” or the like has been specified as data type, another data type recorded in the ROM area 11-2 is read after a complementary check described later. On the assumption of an increase in the number of data types in the future, “FFh” has been assigned as a data type for outputting an expected value.

For example, data on an expected value read from the ROM area 11-2 in response to the executable command “30h” is held in the data latch 12. The data held in the data latch 12 is subjected to a check, such as a complementary check. When having passed the check, the data “Dout” is read to outside the NAND chip 10. After this, a reset command “FFh” is issued, completing the expected value read sequence.

The read expected value is compared with the operation result from the AES arithmetic circuit 17 on the basis of a secret key KEY with the same slot number as that of the expected value and a message supplied from the host device 20. If the comparison result has shown that they coincide with each other, this means that the secret key KEY is normal. If the comparison result has shown that they do not coincide with each other, this means that a defect has occurred in the secret key KEY.

The details of a verification process when an authentication defect has occurred in the NAND chip 10 will be described later.

(Configuration of NAND Flash Memory)

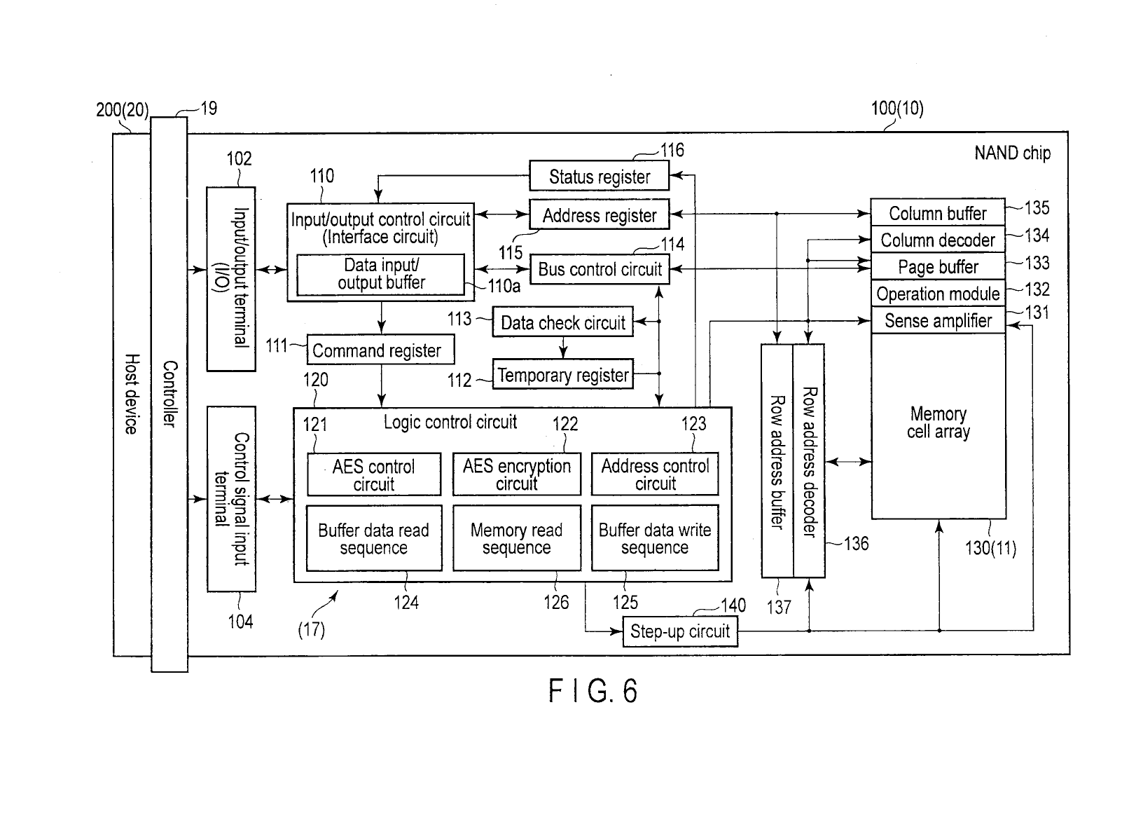

Next, a basic configuration of a NAND chip 100 according to the first embodiment will be explained with reference to FIG. 6. FIG. 6 is a block diagram of a NAND chip 100, which schematically shows a basic configuration of the NAND chip 10 of FIG. 1. In FIG. 6, the same parts as those in FIG. 1 are indicated by the same reference numerals.

As shown in FIG. 6, the NAND chip 100 (10) comprises an input/output terminal (I/O) 102, a control signal input terminal 104, an input/output control circuit 110, a command register 111, a temporary register 112, a data check circuit 113, a bus control circuit 114, an address register 115, a status register 116, a logic control circuit 120, a memory cell array 130 (11), a sense amplifier 131, an operation module 132, a page buffer 133 (12), a column decoder 134, a column buffer 135, a row address decoder 136, a row address buffer decoder 137, and a step-up circuit 140.

The input/output terminal 102 and control signal input terminal 104 are external interfaces that connect a host device 200 (20) and the NAND chip 100 via the controller 19. The input/output terminal 102 includes, for example, a data input/output terminal, a command input terminal, and an address input terminal (which are not shown). The control signal input terminal 104 includes, for example, a WE terminal that supplies a data input clock, an RE terminal that supplies a data output clock, a DQS terminal that transfers a data input/output clock, an enable CLE terminal that inputs data input as a command, an enable ALE terminal that inputs data input as an address, a CE terminal that activates overall functions, including data input/output, and a WP terminal that transfers a write prevention signal for preventing erroneous writing. The control signal input terminal 104 includes a /RE terminal, a /WE terminal, and /DQS terminal that transfer complementary signals at the RE terminal, WE terminal, and DQS terminal as terminals used in realizing data transfer with a high-speed interface. Although not shown in FIG. 6, there are an R/B terminal that shows an internal operating state of the NAND chip 100 and Vcc/Vss/Vccq/Vssq terminals for power supply.

The input/output control circuit 110 is connected to the input/output terminal 102 and registers that hold various parameters. The input/output control circuit 110 includes a data input/output buffer 110a. The data input/output buffer 110 receives data from the data input/output terminal and stores the data in a data storage circuit selected by the column decoder 134. In addition, the data input/output buffer 110a outputs data to the outside via the data input/output terminal. At the data input/output terminal, not only write data but also various commands, including write, erase, and status read, and addresses are input.

The command register 111 outputs a command input from the input/output control circuit 110 to the logic control circuit 120.

The data check circuit 113 checks whether data has an error when transferring the data in the storage area, such as a key used in the AES, to a working area (not shown) of the page buffer 133.

The temporary register 112 is a register that temporarily holds data determined to have no error as a result of checking performed by, for example, the data check circuit 113.

The bus control circuit 114 is a circuit that switches between, for example, the connection of the input/output control circuit 110 and page buffer 133 and the connection of the logic control circuit 120 and page buffer 133.

The address register 115 latches an address supplied from, for example, the host device 200, converts the latched address into an internal physical address, and supplies a column address to the column buffer 135 and a row address to a row address buffer decoder 137.

The status register 116, which is for informing the outside of various internal statuses of the NAND chip 100, includes a ready/busy register that holds data indicating whether the NAND chip 100 is in a ready state or a busy state and a write status register (not shown) that holds data indicating a write pass/fail.

In addition, the status register 116 may include, for example, an erroneous status register that holds data indicating whether there is an erroneously written status (an erroneous writing verify pass/fail) and an excessive writing status register that holds data indicating whether there is an excessively written status (an excessive writing verify pass/fail).

The logic control circuit 120 controls the memory cell array 130, column decoder 134, data input/output buffer 110a, and row address decoder 136.

In addition, the logic control circuit 120 further includes an AES control circuit 121, an AES encryption circuit 122, an address control circuit 123, a buffer data read sequence 124, and a buffer data write sequence 125. In the first embodiment, the AES control circuit 121, AES encryption circuit 122, address control circuit 123, buffer data read sequence 124, and buffer write sequence 125 are collectively called an AES arithmetic circuit 17.

The AES control circuit 121 controls the AES encryption circuit 122.

The AES encryption circuit 122 is an arithmetic device that carries out an AES encryption operation.

The address control circuit 123 generates an address for a page buffer 133 or the temporary register 112 that stores data used in an AES encryption operation.

The buffer data read sequence 124 is a sub-sequence control circuit that performs control to transfer data from the page buffer 133 to the AES encryption buffer 122 or temporary register 112.

The buffer data write sequence 125 is a sequence circuit that transfers data from the AES encryption circuit 122 or temporary register to the page buffer.

The memory read sequence 126 senses data from pages in the memory cell array 130 using the sense amplifier 131 and stores the read data in the page buffer 133.

The logic control circuit 120 operates according to a control signal (e.g., a command latch enable signal CLE, an address latch enable signal ALE, or a ready/busy signal RY/BY) externally input via the control signal input terminal 104 and a command input from the data input/output terminal via the data input/output buffer 110a. That is, the logic control circuit 120 controls the programming, verification, reading, or erasure of data according to the control signal and command.

The memory cell array 130 includes a plurality of bit lines BLs, a plurality of word lines WLs, and a source line SL (which are not shown). The memory cell array 130 is composed of a plurality of blocks BLKs each having electrically rewritable memory cell transistors (also simply referred to as memory cells) MCs (not shown) arranged in a matrix. A memory cell MC, which has a stacked gate including, for example, a control gate electrode and a charge storage layer (e.g., a floating gate electrode), stores two-level or multilevel data according to a change in the threshold value of a transistor determined by the quantity of electric charges injected into the floating gate electrode. The memory cell MC may have a MONOS (Metal-Oxide-Nitride-Oxide-Silicon) structure that traps electrons in a charge trap insulating film (e.g., a nitride film).

The sense amplifier 131, which senses and amplifies the voltage of a bit line BL (column) in the memory cell array 130, stores data in the memory cell array, reads data from the memory cell array, or erases data from the memory cell array.

The operation module 132 can carry out an operation as shown in Boolean algebra between any data latches described later and stores the result in a data latch. The operation module 132 is used in an ordinary operation of the NAND flash memory, such as a write operation or a read operation.

The page buffer 133 is a temporary storage area for latching write data.

Data in a memory cell MC read into the page buffer 133 is output from the data input/output terminal to the outside (controller 100) via the bus control circuit 114 and data input/output buffer 110a.

The column decoder 134 detects the state of the memory cell MC via a bit line BL and applies a write control voltage to the memory cell MC via the bit line BL, thereby writing data into the memory cell MC.

The column buffer 135 stores a column address input from the address register 115.

The column decoder 134 selects a bit line BL according to a column address held in the column buffer 135.

The row address buffer stores a row address input from the address register 115.

The row address decoder 136 decodes a row address held in the row address buffer 137 in a read operation, a write operation, or an erase operation, selects any one of the blocks BLKs, and makes the remaining blocks BLKs unselected. That is, the row address decoder 136 selects a word line EL and select gate lines SGS, SGD in the memory cell array 130, and applies necessary voltages to these lines in a read operation, a write operation, or an erase operation.

The step-up circuit 140 steps up a power supply voltage to generate necessary voltages in programming, verifying, reading, or erasing data under the control of the logic control circuit 120 and supplies the generated voltages to the memory cell array 130, sense amplifier 131, and row address decoder 136.

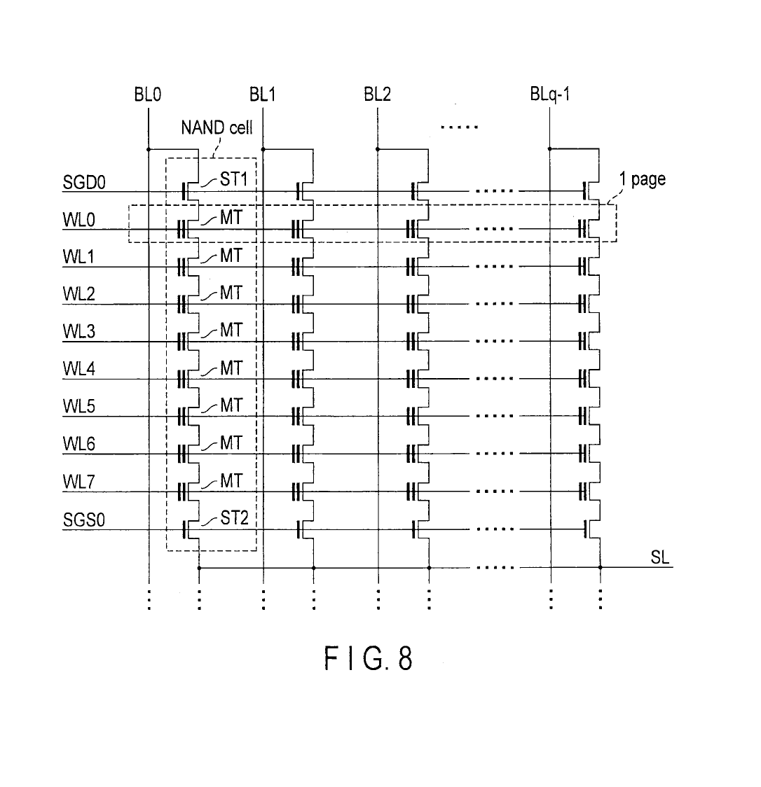

The basic configuration of the memory cell array 130 according to the first embodiment will be explained briefly with reference to FIGS. 7 and 8.

FIG. 7 is a block diagram schematically showing the basic configuration of the memory cell array 130 (11) according to the first embodiment.

The memory cell array 130 is composed of a plurality of memory blocks BLK0 to BLKm-1 (m being an integer not less than one). The memory blocks BLK0 to BLKm-1 are arranged in the direction of a bit line BL (in a column direction).

The way of using the memory blocks BLK0 to BLKm-1 is changed to suit the intended purpose. For example, the memory block BLKi is used as a ROM fuse block. The ROM fuse block BLKi stores various initial setting values necessary for the initialization of the NAND chip 100.

The memory block BLK1 is a key storage block. The key storage block BLK1 includes the aforementioned hidden area 11-1 and ROM area 11-2.

Information stored in the hidden area 11-1 of the key storage block BLK1, which is confidential information that includes protected data, is configured not to be output directly to outside the NAND chip 100 (e.g., to the host device 200). However, in the process of manufacturing a NAND chip 100, it is sometimes hoped that a check will be made to see if key data has been written correctly to test the key storage block BLK1. In this case, specific data is given from outside the NAND chip 100 to the NAND chip 100. The NAND chip 100 carries out an operation on the data and key according to a specific rule and outputs the operation result, thereby determining whether the data has been written in the key storage block BLK1 correctly. The specific data may be the key data itself. In that case, the key data stored in the key storage block BLK1 is XORed with the key data input from outside the NAND chip 100. Then, the result of XORing is output to outside the NAND chip 100.

In another example, a random number generator is further provided in the NAND chip 100. After an operation is carried out on the key data and a random number generated by the random number generator, the operation result is output to outside the NAND chip 100.

When he NAND chip 100 includes a random number generator, if a part of a circuit previously included in the NAND chip 100 can be used to generate a random number, use of this configuration produces the effect of suppressing an increase in the circuit area.

FIG. 8 shows an example of the circuit of one of the memory blocks shown in FIG. 7.

As shown in FIG. 8, a memory block includes a plurality of NAND cells (also referred to as cell units or NAND strings) arranged in the direction of a word line WL (a row direction).

A NAND cell includes a plurality of memory cell transistors MCs connected in series, a select gate transistor ST1 connected to the drain of a memory cell transistor MC at one end, and a select gate transistor ST2 connected to the source of a memory cell at the other end.

A memory cell transistor MC includes a charge storage layer formed above a semiconductor substrate via a gate insulating film, a gate insulating film formed on the charge storage layer, and a control gate electrode formed on the gate insulating film. The number of memory cell transistors MCs is not limited to 8, and may be 16, 32, 64, 128, 256, or the like. The number is not restrictive. In addition, adjacent memory cell transistors MCs share a source and a drain. The memory cell transistors MCs are arranged between the select gate transistors ST1, ST2 in such a manner that their current paths are connected in series. The drain region at one end of the series-connected memory cell transistors MCs is connected to the source region of the select gate transistor ST1, whereas the source region at the other end is connected to the drain region of the select gate transistor ST2.

Bit lines BL0 to BL1-1 (q being an integer not less than one) are connected to the drain of the select gate transistor ST1. A source line SL is connected to the source of the select gate transistor ST2. When there is no need to distinguish between the bit lines BL0 to BLq-1, they will be collectively called bit lines BLs. Both of the select gate transistors ST1, ST2 are not necessarily required. Only one of them may be used, provided that NAND cells can be selected.

Word lines WL0 to WLn-1 (n being an integer not less than one) extend in a WL direction and are shared by memory cells adjacent in the WL direction. Hereinafter, to simplify an explanation, when there is no need to distinguish between the word lines WL0 to WL7, they will be simply called word lines WLs.

The select gate line SGD is connected to the gate electrodes of the select gate transistors ST1 of memory cells in a common connection manner. The select gate line SGS is connected to the gate electrodes of the select gate transistors ST2 of memory cells in a common connection manner.

In addition, data is written in bloc into a plurality of memory cell transistors MCs connected to the same word line WL. This unit is called a page. Furthermore, data is erased in bloc from a plurality of NAND cells in the same row. This unit is called a memory block.

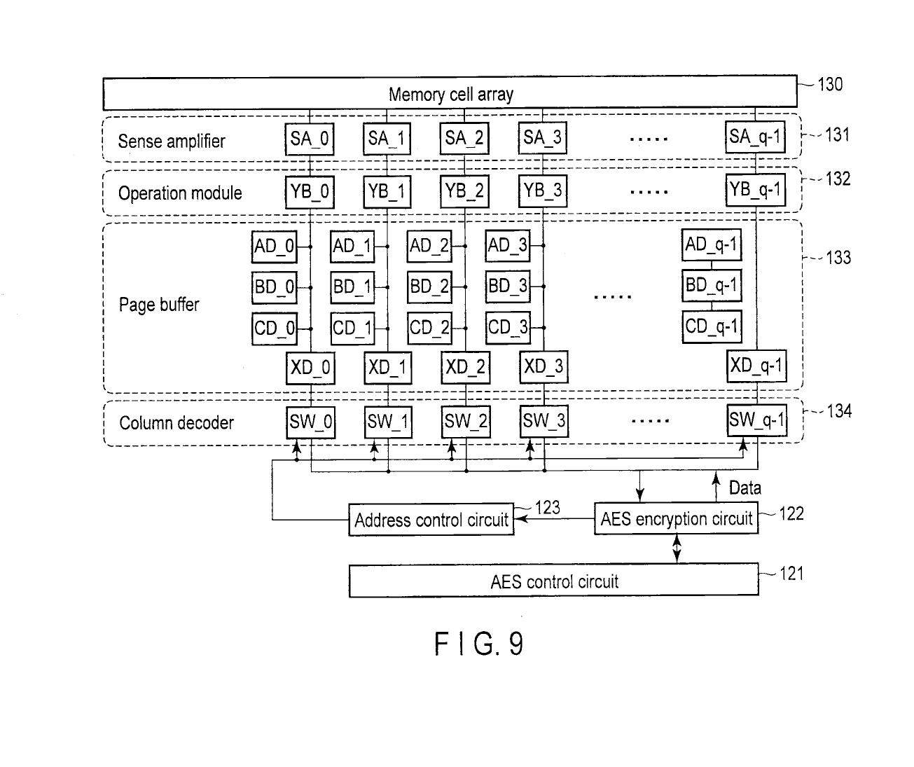

Next, a basic configuration of the page buffer (data latch) 133 according to the first embodiment will be explained briefly with reference to FIG. 9 and FIGS. 12A to 12D.

FIG. 9 is block diagram schematically showing a basic configuration of the page buffer 133 and its peripheral circuitry according to the first embodiment.

As shown in FIG. 9, the sense amplifier 131 includes a plurality of sense modules SA_0, SA_1, SA_2, SA_3, . . . , SA_q-1 connected to bit lines BLs. Hereinafter, when there is no need to distinguish between the sense modules, they will be sometimes simply referred to as sense modules SAs.

The operation module 132 includes a plurality of computing units YB_0, YB_1, YB_2, YB_q-1 connected to the sense modules SAs in a one-to-one correspondence. Hereinafter, when there is no need to distinguish between the computing units, they will be sometimes simply referred to as computing units YBs.

In the page buffer 133, a plurality of latch circuits AD_0, BD_0, CD_0, and XD_0 are connected to a sense module SA. That is, each sense module SA is provided with four latch circuits. Hereinafter, when there is no need to distinguish between the latch circuits, they will be sometimes simply referred to as latch circuits AD, BD, CD, or XD.

The column decoder 134 includes a plurality of switches SW_0, SW_1, SW_2, SW_3, SW_q-1 connected to the buffer circuits XDs in a one-to-one correspondence. Hereinafter, when there is no need to distinguish between the switches, they will be sometimes simply referred to as switches SWs.

The address control circuit 123 supplies an address selection signal to each switch SW, thereby controlling the column decoder 134.

The AES encryption circuit 122 transmits and receives data to and from the page buffer 133 via the column decoder 134. In addition, the AES encryption circuit 122 controls the address control circuit 123.

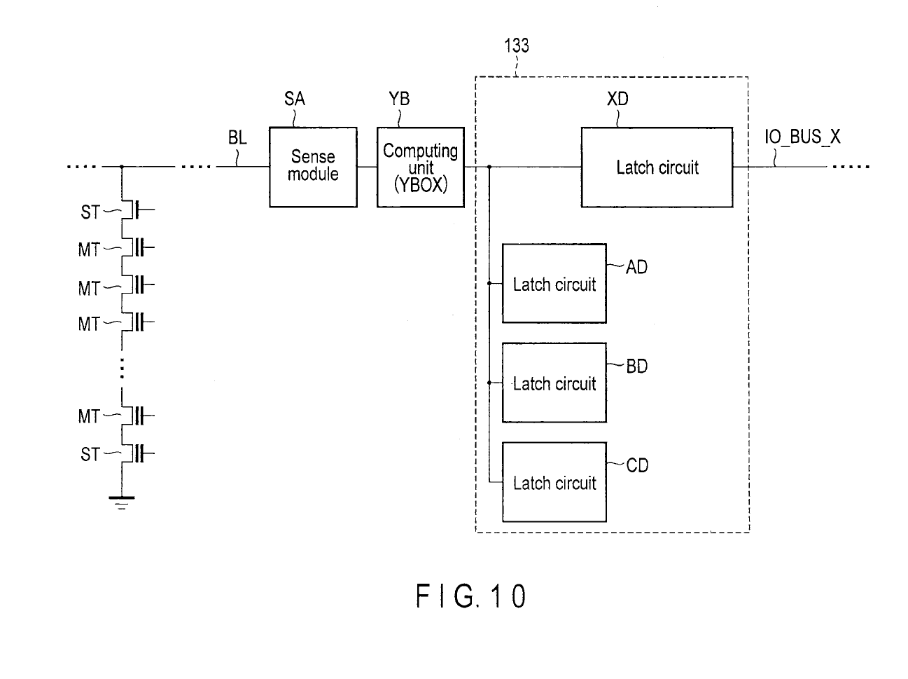

FIG. 10 is a circuit diagram schematically showing an example of the page buffer 133 and its peripheral circuitry.

A plurality of latch circuits AD, BD, CD, XD are connected to a sense module SA via a computing unit (YBOX) YB. At least one of the page buffers (the latch circuit XD in the first embodiment) is directly connected to a data line IO_BUS_X connecting a data input/output terminal (not shown) in the input/output terminal 102 and a data input/output buffer (a data line connecting the page buffer 133 and bus control circuit 114 shown in FIG. 6). Each latch circuit can hold data.

For example, in various sequences, data to be written from the host device 200 into the memory cell array 130 is held in the latch circuit XD. In addition, data read from the memory cell array 130 and output to the host device 200 is held in the latch circuit XD.

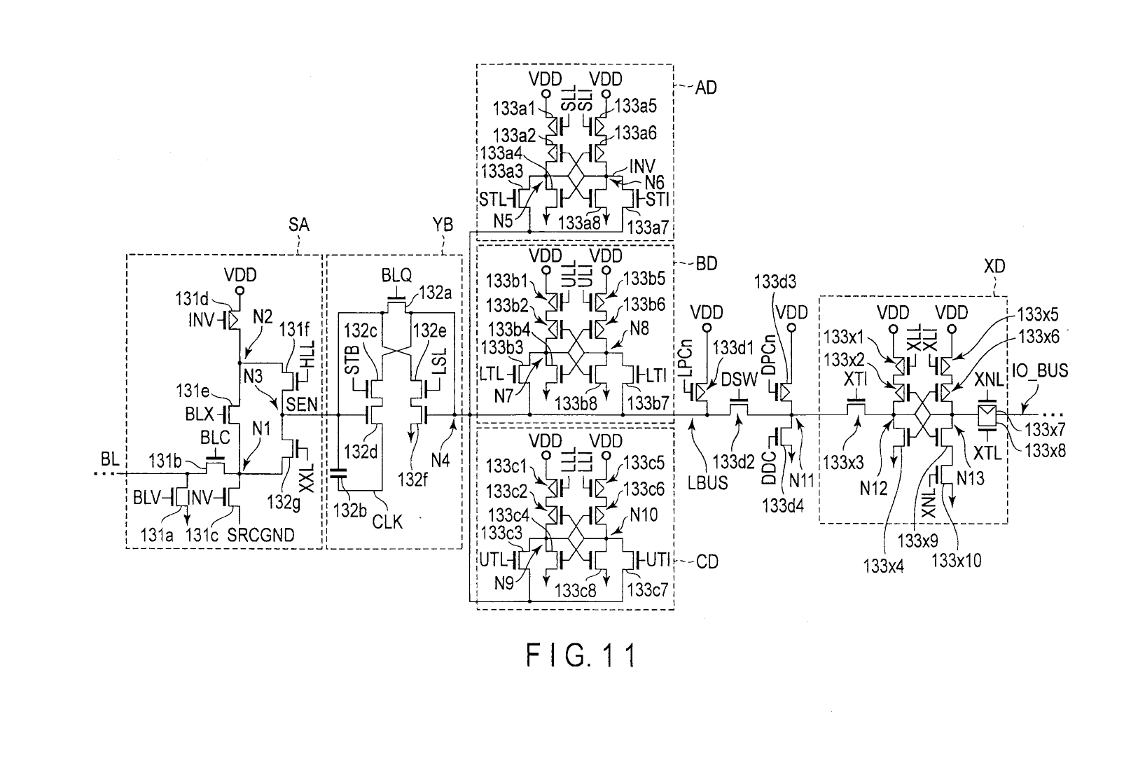

FIG. 11 is a circuit more concretely showing the page buffer 133 and its peripheral circuitry.

A sense module SA includes an n-type transistor 131a one end of whose current path is connected to a bit line BL, to whose gate a signal BLV is supplied, and the other end of whose current path is grounded, an n-type transistor 131b one end of whose current path is connected to a bit line BL, to whose gate a signal BLC is supplied, and the other end of whose current path is connected to node N1, and a transistor 131c one end of whose current path is connected to node N1, to whose gate a signal INV is supplied, and the other end of whose current path is connected to an SRCGND potential. In addition, the sense module SA further includes a p-type transistor 131d one end of whose current path is connected to a power supply VDD, to whose gate a signal INV is supplied, and the other end of whose current path is connected to node N2, an n-type transistor 131e one end of whose current path is connected to node N2, to whose gate a signal BLX is supplied, and the other end of whose current path is connected to node N1, an n-type transistor 131f one end of whose current path is connected to node N2, to whose gate a signal HLL is supplied, and the other end of whose current path is connected to node N3 (=SEN), and an n-type transistor 131g one end of whose current path is connected to node N3, to whose gate a signal XXL is supplied, and the other end of whose current path is connected to node N1.

A computing unit YB includes an n-type transistor 132a one end of whose current path is connected to node N3, to whose gate a signal BLQ is input, and the other end of whose current path is connected to node N4, and a capacitor 132b one end of which is connected to node N3 and to the other end of which a signal CLK is input. In addition, the computing unit YB further includes an n-type transistor 132c one end of whose current path is connected to node N4 and to whose gate a signal STB is input, and an n-type transistor 132d one end of whose current path is connected to the other end of the current path of the transistor 132c, whose gate is connected to node SEN, to the other end of whose current path a signal CLK is input. Moreover, the computing unit YB further includes a transistor 132e one end of whose current path is connected to node N3 and to whose gate a signal LSL is input, and a transistor 132f one end of whose current path is connected to the other end of the current path of the transistor 132e, whose gate is connected to node N4 (=data line LBUS), and the other end of whose current path is grounded.

A buffer circuit AD includes a p-type transistor 133a1 to one end of whose current path the power supply VDD is input and to whose gate a signal SLL is supplied, a p-type transistor 133a2 to one end of whose current path the other end of the current path of the transistor 133a1 is connected, whose gate is connected to node N6 (=INV), the other end of whose current path is connected to node N5, an n-type transistor 133a3 one end of whose current path is connected to node N5, to whose gate a signal STL is supplied, and the other end of whose current path is connected to node N4, and an n-type transistor 133a4 one end of whose current path is connected to node N5, whose gate is connected to node N6, and the other end of whose current path is grounded. In addition, the buffer circuit AD further includes a p-type transistor 133a5 to whose current path the power supply VDD is input, and to whose gate SLI is input, a p-type transistor 133a6 to one end of whose current path the other end of the current path of the transistor 133a5 is connected, whose gate is connected to node N5, and the other end of whose current path is connected to node N6, an n-type transistor 133a7 one end of whose current path is connected to node N6, to whose gate a signal STI is input, and the other end of whose current path is connected to node N4, and an n-type transistor 133a8 one end whose current path is connected to node N6, whose gate is connected to node N5, and the other end of whose current path is grounded.

A buffer circuit BD includes a p-type transistor 133b1 to one end of whose current path the power supply VDD is input and to whose gate a signal ULL is input, a p-type transistor 133b2 to one end of whose current path the other end of the current path of the transistor 133b1 is connected, whose gate is connected to node N8, and the other end of whose current path is connected to node N7, an n-type transistor 133b3 one end of whose current path is connected to node N7, to whose gate a signal LTL is input, and the other end of whose current path is connected to node N4, and an n-type transistor 133b4 one end of whose current path is connected to node N7, whose gate is connected to node N8, and the other end of whose current path is grounded. In addition, the buffer circuit BD further includes a p-type transistor 133b5 to one end of whose current path the power supply VDD is input and to whose gate a signal ULI is input, a p-type transistor 133b6 to one end of whose current path the other end of the current path of the transistor 133b5 is connected, whose gate is connected to node N7, and the other end of whose current path is connected to node N8, an n-type transistor 133b7 one end of whose current path is connected to node N8, to whose gate a signal LTI is input, and the other end of whose current path is connected to node N4, and an n-type transistor 133b8 one end of whose current path is connected to node N8, whose gate is connected to node N7, and the other end of whose current path is grounded.

A buffer circuit CD includes a p-type transistor 133c1 to one end of whose current path the power supply VDD is input and to whose gate a signal LLL is input, a p-type transistor 133c2 to one end of whose current path the other end of the current path of the transistor 133c1 is connected, whose gate is connected to node N10, and the other end of whose current path is connected to node N9, an n-type transistor 133c3 one end of whose current path is connected to node N9, to whose gate a signal UTL is input, and the other end of whose current path is connected to node N4, and an n-type transistor 133c4 one end of whose current path is connected to node N9, whose gate is connected to node N10, and the other end of whose current path is grounded. In addition, the buffer circuit CD further includes a p-type transistor 133c5 to one end of whose current path the power supply VDD is input and to whose gate a signal LLI is input, a p-type transistor 133c6 to one end of whose current path the other end of the current path of the transistor 133c5 is connected, whose gate is connected to node N9, and the other end of whose current path is connected to node N10, an n-type transistor 133c7 one end of whose current path is connected to node N10, to whose gate a signal UTI is input, and the other end of whose current path is connected to node N4, and an n-type transistor 133c8 one end of whose current path is connected to node N10, whose gate is connected to node N9, and the other end of whose current path is grounded.

Furthermore, between the buffer circuits BD and XD, there are provided a p-type transistor 133d1 to one end of whose current path the power supply VDD is supplied, to whose gate a signal LPCn is input, and the other end of whose current path is connected to node N4, an n-type transistor 133d2 one end of whose current path is connected to node N4, to whose gate a signal DSW is input, and the other end of whose current path is connected to node N11, a p-type transistor 133d3 to one end of whose current path the power supply VDD is supplied, to whose gate a signal DPCn is supplied, and the other end of whose current path is connected to node N11, and an n-type transistor 133d4 one end of whose current path is connected to node N11, to whose gate a signal DDC is supplied, and the other end of whose current path is grounded. Here, the signal LPCn precharges a data line LBUS when it is low (L). The signal DSW is a signal that connects the data line LBUS and the latch circuit XD. The signal DPCn and signal DDC are signals that precharge or discharge the latch circuit XD.

The latch circuit XD includes a p-type transistor 133x1 to one end of whose current path the power supply VDD is supplied and to whose gate a signal XLL is input, a p-type transistor 133x2 to one end of whose current path the other end of the current path of the transistor 133x1 is connected, whose gate is connected to node N13, and the other end of whose current path is connected to node N13, an n-type transistor 133x3 one end of whose current is connected to node N12, to whose gate a signal XTI is input, and the other end of whose current path is connected to node N11, and an n-type transistor 133x4 one end of whose current is connected to node N12, whose gate is connected to node N13, and the other end of whose current path is grounded. In addition, the latch circuit XD further includes a p-type transistor 133x5 to one end of whose current path the power supply VDD is supplied and to whose gate a signal XLI is input and a p-type transistor 133x6 to one end of whose current path the other end of the current path of the transistor 133x5 is connected, whose gate is connected to node N12, and the other end of whose current path is connected to node N13. Moreover, the latch circuit XD further includes a p-type transistor 133x7 one end of whose current is connected to node N13, to whose gate a signal XNL is input, and the other end of whose current path is connected to a data line IO_BUS_X, an n-type transistor 133x8 one end of whose current is connected to node N13, to whose gate a signal XTL is input, and the other end of whose current path is the data line IO_BUS_X, an n-type transistor 133x9 one end of whose current is connected to node N13, whose gate is connected to node N12, and an n-type transistor 133x10 one end of whose current is connected to the other end of the current path of the transistor 133x9, to whose gate a signal XNL is supplied, and the other end of whose current path is grounded.

Next, an address space of the storage area in the page buffer 133 used in the AES encryption circuit 122 according to the first embodiment will be explained briefly with reference to FIGS. 12A to 12D. FIG. 12A is a schematic diagram showing a basic configuration of the page buffer 133 according to the first embodiment. FIG. 12B is a schematic diagram of the area divided by the functions of the page buffer 133 according to the first embodiment. FIG. 12C is a schematic diagram of a more detailed allocation of the page buffer 133 according to the first embodiment.

In the key storage block BLK1 of the memory cell array 130, many data sets (slots) have been stored as described above. The host device 200 determines which one of the slots is to be used for operations. In the slot, the total amount of data may extend over several pages. In addition, the page length may differ, depending on the product. An address space the AES arithmetic device actually uses as a RAM is about 49 bytes in size. It is very small as compared with the memory cell array 130 with a page capacity of 16 kilobytes. As described above, the area the AES arithmetic device uses as a RAM is small.

As shown in FIG. 12A, before the page buffer 133 is used as a RAM of the AES encryption circuit 122, the page buffer 133 has not been divided into an area (a working area) acting as an arithmetic RAM of the AES encryption circuit 122 and a key storage area for storing information on a key or the like. However, as shown in FIG. 12B, when the page buffer 133 is used as a RAM of the AES encryption circuit 122, a module described later divides the page buffer 133 into an area (a working area) 133a serving as an arithmetic RAM with which the AES encryption circuit 122 carries out an operation and an area (a key storage area) 133b in which information on a key or the like is to be stored.

More specifically, as shown in FIG. 12C, a key storage area 133t holds confidential information (Media Key) MKEY and secret key data KEY about a plurality of slots SLT_0 to SLT_E. In the first embodiment, the confidential information MKEY is not related to the gist of the embodiment and therefore a concrete explanation of it will be omitted.

Message data MESSAGE is loaded from outside the NAND chip 100 into a working area 133s. In addition, a module described later transfers one set of the key data items in SLT_0 to SLT_E in the key storage area 133t. The transferred key data is key data to be used by the AES encryption circuit 122 in calculations. After the AES encryption operation described later has been completed, authentication information is written into the working area 133s as shown in FIG. 12D.

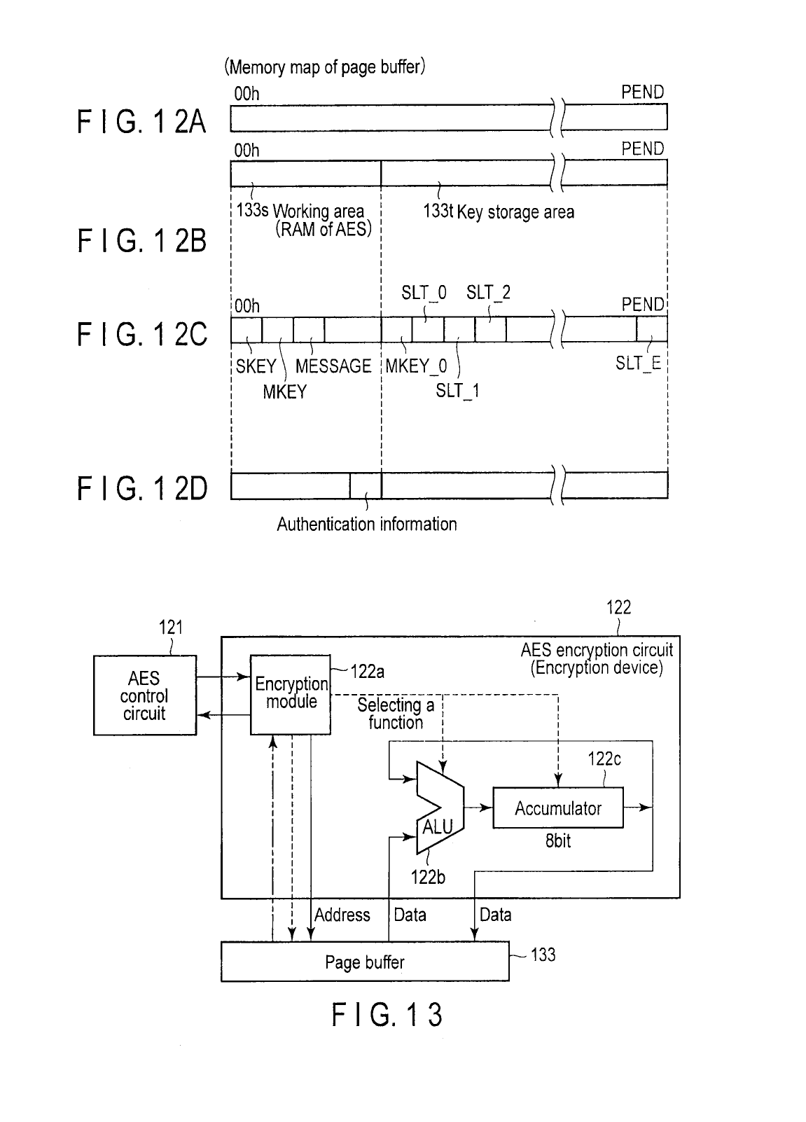

Next, a basic configuration of the AES encryption circuit 122 according to the first embodiment will be explained with reference to FIG. 13. FIG. 13 is a block diagram schematically showing a basic configuration of the AES encryption circuit 122 according to the first embodiment.

As shown in FIG. 13, the AES encryption circuit 122 comprises an encryption module 122a, an arithmetic and logic unit (ALU) 122b that carries out an operation for encryption, and an accumulator 122c for storing the operation result temporarily.

The AES encryption circuit 122 controls the operation of AES encryption according to a control signal from the AES control circuit 121 and outputs a status signal indicating the status of the operation.

The ALU 122b carries out an operation on the basis of information representing a function selected by the encryption module 122a (“Selecting a function” in FIG. 13). The ALU 122b carries out an operation on address data specified by the encryption module 122a as needed.

The accumulator 122c is a register for storing the operation result from the ALU 122b. Data stored in the accumulator 122c is written into the page buffer 133 according to an instruction from the encryption module 122a.

The AES encryption circuit 122 carries out the operation for AES encryption using a part of the storage area of the page buffer 133.

Having received an encryption instruction from the host device 200 via the AES control circuit 121, the encryption module 122a specifies the address of the page buffer 133, causing the ALU 122b to carry out an operation on the data. On the basis of the input data from the host device 200, the AES encryption circuit 122 carries out an operation following a procedure determined by an AES encryption method and outputs the resulting data. The operation is expressed by the following equation:

R=AES (m, k)

R: Result; operation result, m: Message

k: key

The AES encryption arithmetic device, which includes the following five instructions, carries out operations in bytes. Three of them are AES internal operation instructions (sbox, xtime, and xor) and the remaining two are two types of memory access instructions (ld (load) and st (store)).

[Operation Instructions]

1. Sbox

2. xtime

3. xor

[Memory Access Instructions]

4. ld (load)

5. st (store)

The way of using the AES encryption circuit 122 is as follows:
Write input data (message m (16 bytes) and key k (16 bytes) into the page buffer 133
Start to activate the AES encryption circuit 122
Waite for the AES encryption circuit 122 to complete the operation
Read the operation result from the page buffer 133 since the operation result has been written in the page buffer

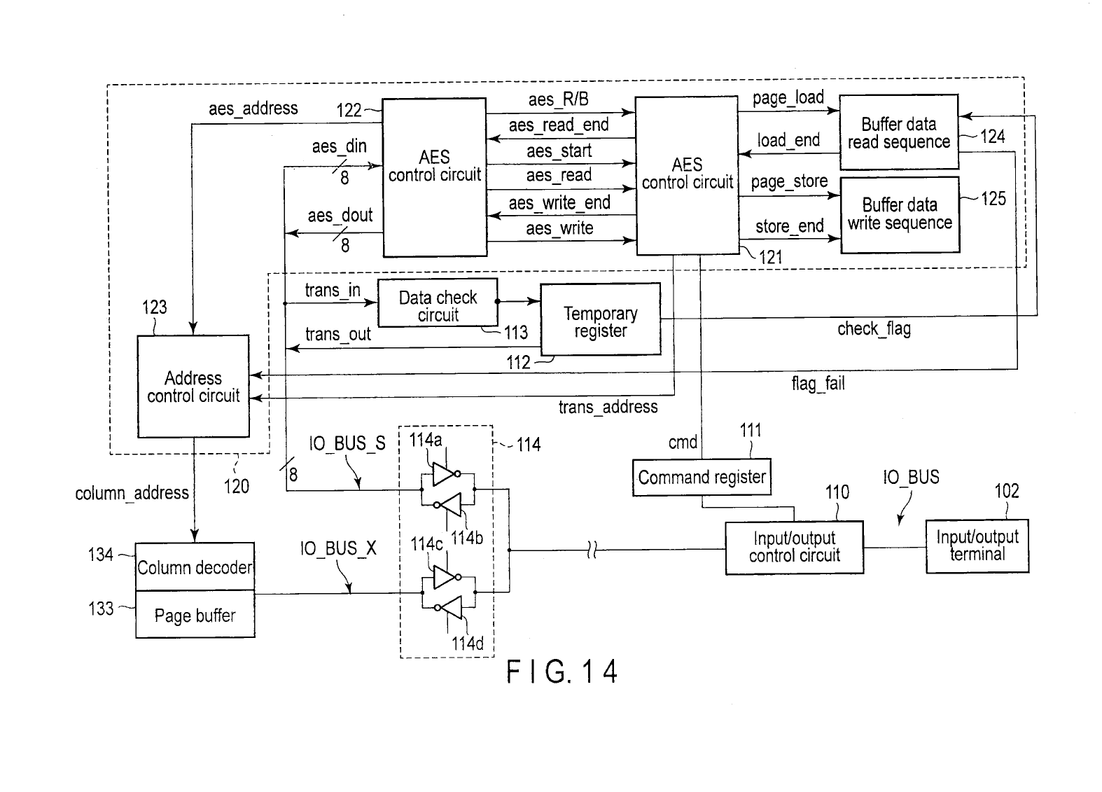

Next, a basic configuration of the AES encryption arithmetic device according to the first embodiment and the flow of signals in the device will be explained with reference to FIG. 14. FIG. 14 is a block diagram schematically showing a basic configuration of the AES encryption arithmetic device according to the first embodiment and the flow of signals in the device.

As shown in FIG. 14, a command register 111 in the NAND chip 100 receives a command to start an AES encryption sequence from the host device 200 via the input/output terminal 102 and input/output control circuit 110. The command register 111 holds the command and sends it as an encryption executable command cmd to the AES control circuit 121. Having received the encryption executable command cmd, the AES control circuit 121 sends a signal aes_start to the AES encryption circuit 122. When having received the signal aes_start, the AES encryption circuit 122 starts an AES encryption sequence.

In addition, having received the signal aes_start, the AES encryption circuit 122 sends back a signal aes_R/B indicating the state of the operation to the AES control circuit 121. For example, the AES encryption circuit 122 transmits aes_R/B as a busy signal to the AES control circuit 121 if it is activating the AES encryption sequence.

When having to load or store data during the AES encryption sequence, the AES encryption circuit 122 transmits a signal aes_read or aes_write to the AES control circuit 121, respectively. The AES encryption circuit 122 specifies the address of the RAM (page buffer 133) using a signal aes_address and transmits the signal aes_address to an address control circuit (column address control circuit) 123. The address control circuit 123 converts the address signal into a physical address and transmits a signal column address to the column decoder 134, thereby specifying the bits belonging to the corresponding address in the page buffer 133.

In addition, the AES encryption circuit 122 can control the address control circuit 123 according to the state of the sequence, thereby changing the address.

The address control circuit 123 can convert an address supplied from the AES encryption circuit 122 into an address in the working area 113s of the page buffer 133.

The AES encryption circuit 122 can transmit and receive data to and from the page buffer 133 via an 8-bit data line IO_BUS_S (a data line connecting the logic control circuit 120 and bus control circuit 114 in FIG. 2), a bus control circuit 114, and a data line IO_BUS_X. The bus control circuit 114 includes an inverter 114a whose input end is connected to a data line IO_BUS_S, an inverter 114b to whose input end the output end of the inverter 114a is connected and whose output end is connected to a data line IO_BUS_S, an inverter 114c whose input end is connected to a data line IO_BUS_X, and an inverter 114d to whose input end the output end of the inverter 114c, the output end of the inverter 114a, and the input end of the inverter 114b are connected. An output end of the inverter 114d is connected to the data line IO_BUS_X.

In addition, the data line IO_BUS_S is provided with the data check circuit 113 and temporary register 112. The data check circuit 113 checks whether data has an error when data on a key or the like is transferred to the working area 133s of the page buffer 133. The temporary register 112 temporarily holds data determined to have no error to transfer the data to the working area at the data check circuit 113 before AES operations are carried out. In addition, the address of data in the page buffer 133 can be converted via the temporary register 112.

The AES control circuit 121 is connected to a buffer data read sequence 124 that performs control to transfer data from the page buffer 133 to the AES encryption circuit 122 and to a buffer data write sequence 125 for transferring data from the AES encryption circuit 122 to the page buffer.

When having received a memory load (read) instruction from the AES encryption circuit 122, the AES control circuit 121 transmits a signal page_load to the buffer data read sequence 124. When having received a signal page_load, the buffer data read sequence 124 starts a subsequence. After having completed the operation, the buffer data read sequence 124 transmits a signal load_edn to the AES control circuit 121 and terminates the subsequence of the buffer data read sequence 124.

When having received a memory store (write) instruction from the AES encryption circuit 122, the AES control circuit 121 transmits a signal page_read to the buffer data write sequence 125. When having received the signal page_read, the buffer data write sequence 125 starts a subsequence. After having completed the operation, the buffer data write sequence 125 transmits a signal store end to the AES control circuit 121 and terminates the subsequence of the buffer data write sequence 125.

(Authentication Operation Sequence)

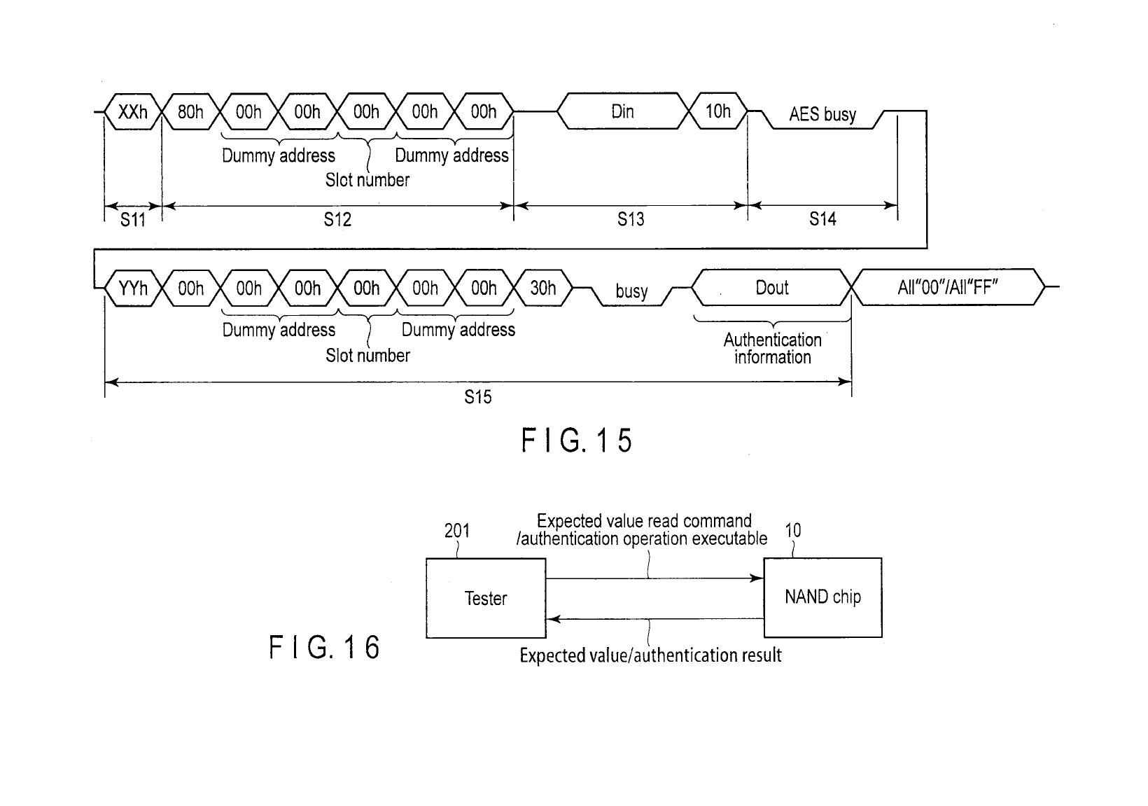

FIG. 15 shows an authentication operation sequence according to the first embodiment.

[Step S11]

The host device 200 (20) inputs message data to the input/output terminal 102 of the NAND chip 100 (10) via the controller 19. The message data includes, for example, a special command XXh for an AES sequence at its head. The AES control circuit 121 supplies trans_address to the address control circuit 123, thereby causing the message data supplied from the host device 200 to be stored in predetermined addresses of the working area (not shown) of the page buffer 133.

[Step S12]

The host device 200 specifies a slot number and inputs it to the NAND chip 100 (input/output terminal 102). Specifically, the host device 200 selects any one of many slots and determines a number of the slot. Then, in the host device 200, command “80h” and dummy address “00h” are supplied to the input/output terminal 102 in two consecutive cycles, then the slot number is supplied, and thereafter dummy address “00h” is supplied in two cycles. A NAND chip 100 (address control circuit 123) converts the slot number into a column address.

Suppose, in step S12, when the host device 200 has input command “XXh” to the input/output terminal 102, a block and a page in which secret key data has been written is specified automatically and a dummy address is input to the input/output terminal 102, except for an address that specifies a slot number.

[Step S13]

When command “10h” has been supplied after the host device 200 had supplied message data Din, for example, “FFh,” to the NAND chip 10 via the controller 19, if command “XXh” has been input at the head of the command sequence, the AES control circuit 121 interprets command “10h” as an executable command for an authentication operation and starts an authentication operation sequence.

When the host device 200 has input an AES executable command “10h” to the AES control circuit 121, the AES control circuit 121 reads page data from the memory cell array 130 that has stored secret key data KEY into the page buffer 133. That is, the AES control circuit 121 instructs the memory read sequence 126 to sense data from pages in the memory cell array 130 by use of the sense amplifier 131 and store the read data into the page buffer 133.

In the memory cell array 130, several sets of secret key data items KEYs are stored in complementary data format in each slot. Therefore, data trans_in is in complementary data format. For a check described later, a slot key is recorded in complementary form in a multiplex manner, which enables erroneous data to be replaced with correct data if there is any error in the checked data.

Next, secret key data KEY in a slot specified in step S12 is copied into the working area (not shown) of the temporary register 112. The data check circuit 113 checks whether data trans_in is correct in the course of transferring data trans_in from the page buffer 113 to the temporary register 112. Specifically, the data check circuit 113 checks complementary data of key data. If the data is kept in complementary form, data trans_in is transferred directly to the temporary register 112.

If having failed in the complementary check, the data check circuit 113 transmits check_flag to the buffer data read sequence 124 via the temporary register 112. Thereafter, the buffer data read sequence 124 transmits flag_fail to the address control circuit 123. The address control circuit 123 specifies another address in which secret key data KEY in the same slot has been written and tries to transfer data trans_in to the data check circuit 113 again. In this way, data trans_in is checked repeatedly until the complementary check has succeeded. Therefore, data from which error bits have been removed is stored the temporary register 112. In this example, when a complementary check has failed, the address control circuit 123 has specified another address in which secret key data KEY in the same slot has been written. However, the way the address control circuit 123 takes is not necessarily restricted to this.

If the complementary check has succeeded, the secret key data in the slot specified in step S12 is copied into the temporary register 112. The temporary register 112 includes a storage area that has at least the same size as the data length of the secret key data KEY in the slot.

To transfer the data stored in the temporary register 112 to the working area 133s of the page buffer 133, the AES control circuit 121 activates the subsequence of the buffer data write sequence 125. The address control circuit 123 specifies transfer destination address trans_address in the working area 133s. Data trans_out in the temporary register 112 is transferred to the page buffer 133 via the data line IO_BUS_S, bus control circuit 114, and data line IO_BUS_X. After the transfer of data has been completed, the address control circuit 123 increments the address and, in synchronism with this increment, increments the address of the temporary register 112. Each time the address of the temporary register 112 is incremented, the temporary register 112 transfers one byte of data to the page buffer 113. The transfer operation is repeated until the length of the secret key data KEY has been reached, thereby completing the copying of the key data into the working area 133s.

[Step S14]

After a message input from outside the chip and the secret key data KEY in the slot have been copied into the AES working area, the NAND chip 100 (AES arithmetic circuit 122) carries out an operation. During the operation, the NAND chip 100 outputs a busy signal aes_R/B (busy) to the host device 200 via the AES control circuit 21 and an RB (ready-busy) pad (not shown). The RB pad outputs a busy signal to the host device 200 until the AES operation sequence has been completed.

In a state where the authentication operation at the AES encryption circuit 122 has been completed and the NAND chip 10 has output a ready signal, the page buffer 133 in the NAND chip 10 holds the authentication operation result.

[Step S15]

Thereafter, when the host device 20 has supplied, to the NAND chip 10 via the controller 19, command “YYh,” command “00h,” two cycles of dummy addresses, a slot number, and two cycles of dummy addresses, and further executable command “30h,” the NAND chip 10 goes into a busy state. In this state, the authentication operation result in the page buffer 133 is selected. Then, when the ready/busy signal has gone into a ready state, the authentication operation result in the page buffer is supplied to the host device 200 by way of the bus control circuit 114, input/output control circuit 110, input/output terminal 102, and controller 19.

The host device 200 compares the received authentication operation result with the expected value read from the ROM area 11-2 stored in a memory provided in the host device 200. If the comparison result has shown that the authentication operation result coincides with the expected value, it is determined that the secret key data KEY is normal. If they do not coincide with each other, it is determined that a defect has occurred in the secret key data KEY.

(Configuration in Determining a Defect)

FIG. 16 schematically shows a case where the NAND chip 10 is tested with a tester 201 acting as a semiconductor test device. That is, FIG. 16 shows a case where the host device 20 (200) is a tester 201.

The tester 201 supplies the expected value read command to the NAND chip 10, reads an expected value EXP from a slot of the ROM area 11-2 of the NAND chip 10, and holds the expected value EXP in a memory (not shown) in the tester 201.

Thereafter, the tester 201 causes the NAND chip 10 to activate an authentication operation sequence shown in FIG. 15. That is, using the secret key data KEY stored in the NAND chip 10, the tester 201 causes the AES arithmetic circuit 17 of the NAND chip 10 to carry out an arithmetic operation. The tester 201 takes in the authentication result obtained from the operation and holds the result in the memory (not shown).

After this, the tester 201 compares the expected value held in the memory with the authentication result and determines a defect, depending on whether the expected value coincides with the authentication result. If the expected value coincides with the authentication result, the secret key data is normal. If they do not coincide with each other, it is determined that a defect has occurred in the secret key data KEY.

### Effects of the First Embodiment

With the first embodiment, the memory cell array 11 of the NAND chip 10 includes the hidden area 11-1 which is inhibited from being externally written into and read from and the ROM area 11-2 which is inhibited from being written into and permitted to be read from. In the hidden area 11-1, a plurality of secret key data items KEYs have been stored. In the ROM area 11-2, a plurality of encrypted key data items EKEYs and a plurality of expected values EXPs corresponding to the secret key data items respectively have been stored. The AES arithmetic circuit 17 serving as an authentication circuit carries out an authentication operation on the basis of the secret key data KEY and an externally supplied message and outputs the result to the outside. Therefore, for example, the test device compares the expected value read from the ROM area 11-2 with the authentication result obtained from the AES arithmetic circuit 17, thereby making it possible to determine whether a defect has occurred in the secret key data KEY.

Accordingly, in a test before shipment, the expected value read from the ROM area 11-2 is compared with the authentication result obtained from the AES arithmetic circuit 17 without supplying the expected value to the NAND chip 10, thereby making it possible to determine whether a defect has occurred in the secret key data KEY.

In addition, if a defect failed in authentication has occurred after shipment, the determination is made as to each secret key data item, making it possible to determine in which slot the secret key data has contributed to the occurrence of the defect.

### Second Embodiment

With the first embodiment, when an authentication defect has occurred in the NAND chip 10, for example, the test device 201 can read the expected value EXP and authentication operation result from the NAND chip 10 and determine a secret key data item KEY in which a defect has occurred.

In contrast, a second embodiment enables the NAND chip 10 to carry out a BIST (Built In Self Test). That is, only status data is output as the test result from the NAND chip 10 without outputting the expected value EXP and authentication operation result to outside the NAND chip 10, thereby making it possible to analyze a defect in the secret key data KEY.

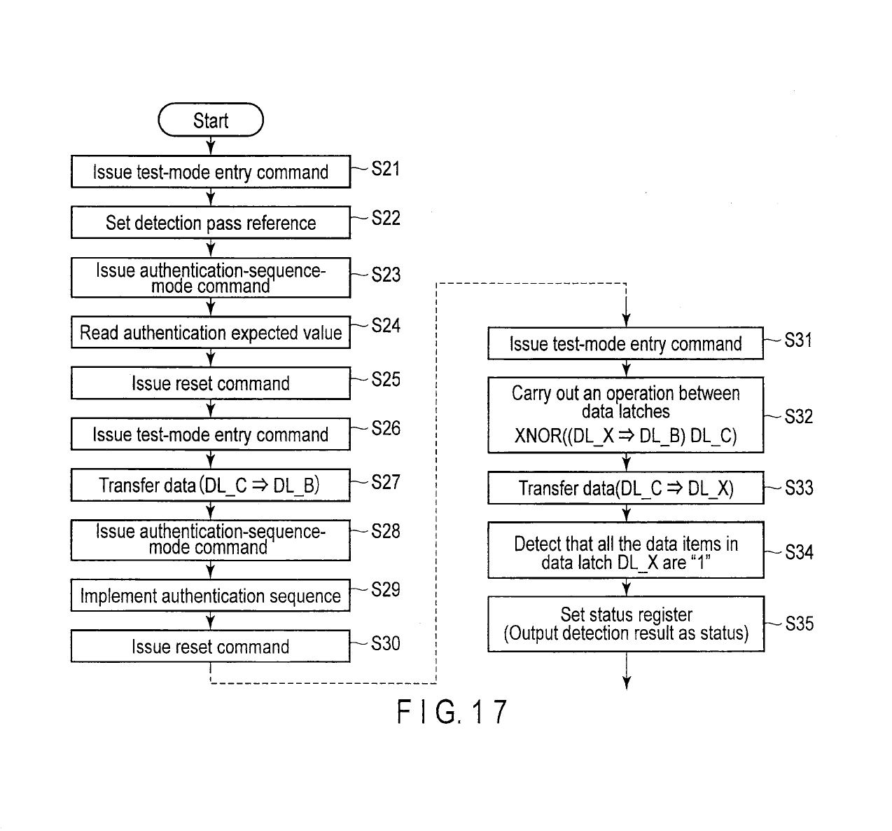

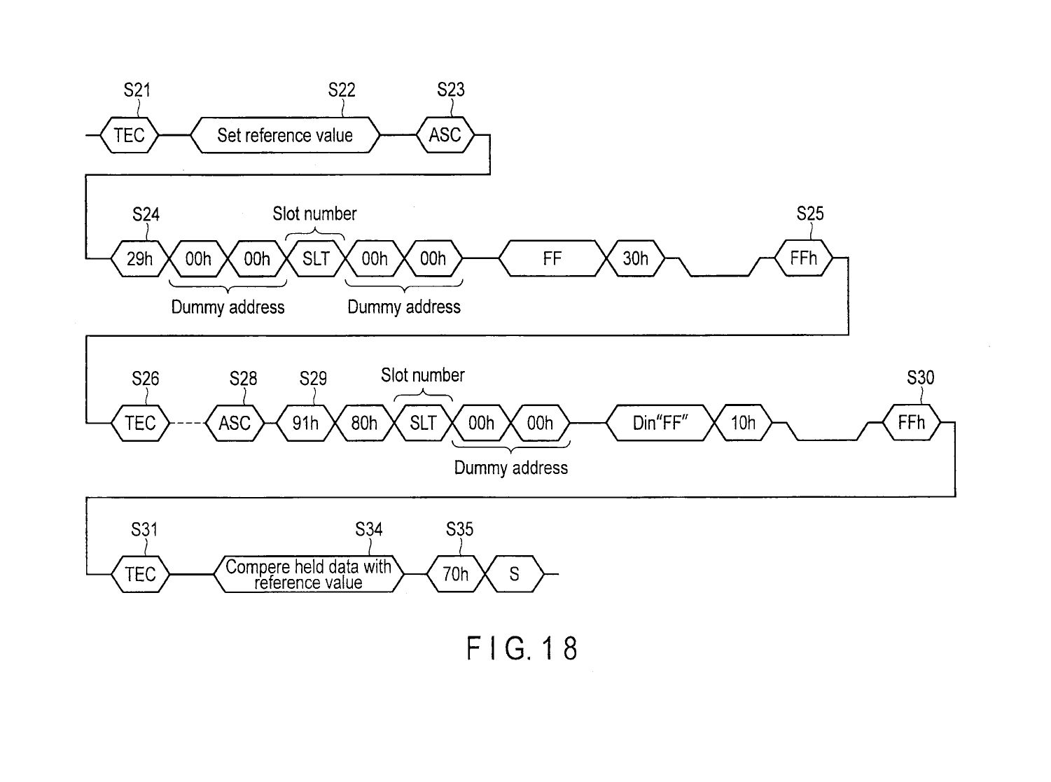

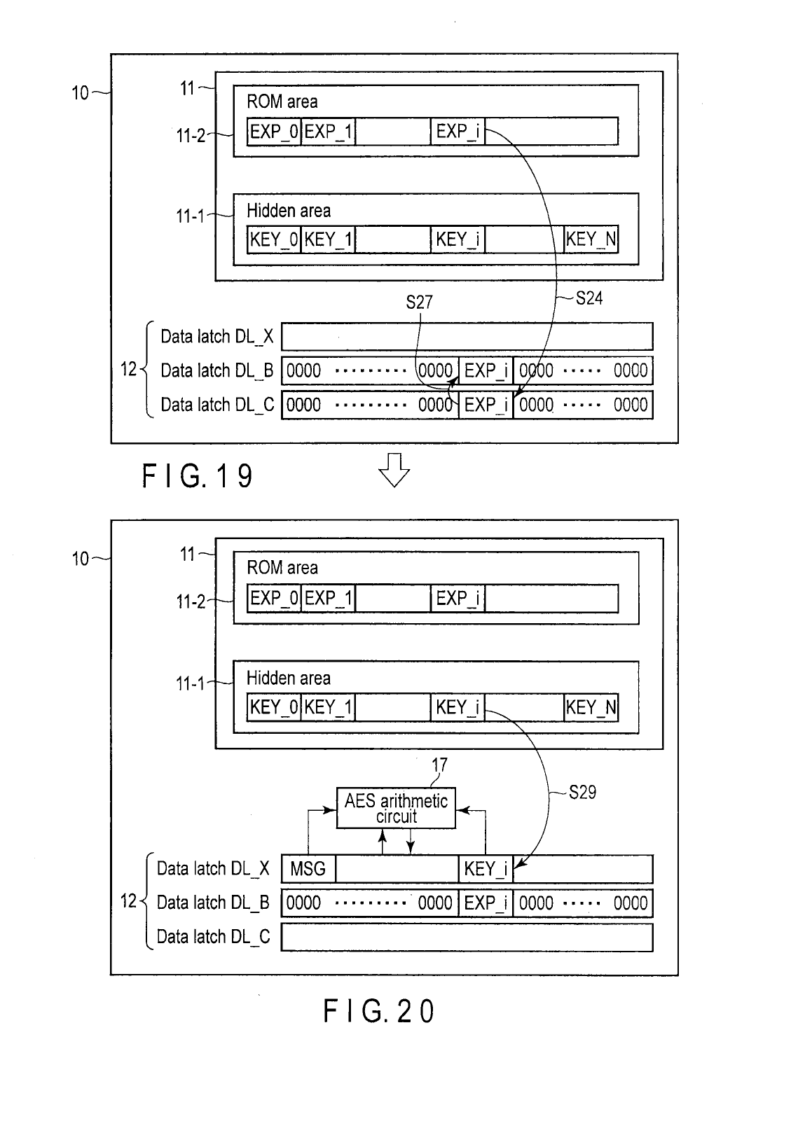

FIG. 17 shows a sequence of the second embodiment, FIG. 18 shows a command sequence of the second embodiment, and FIGS. 19 to 24 show operations of the memory cell array 11 and data latch 12. A BIST operation will be explained with reference to FIGS. 17 to 24.

As described above, the data latches 12 are each composed of latch circuits AD, BD, CD provided so as to correspond to bit lines and sense amplifiers and a latch circuit XD connected to the bus IO_BUS. In FIG. 19, the latch circuit AD is omitted. Either the latch circuit BD or CD can be changed to a latch circuit AD.

In the explanation below, the latch circuits XD, BD, CD are referred to as data latches DL_X, DL_B, BL_C.

[Step S21]

First, to make valid an operation of the test system, the test device 201 issues an entry command (TEC) in a test mode and supplies the command to the NAND chip 10.

[Step S22]

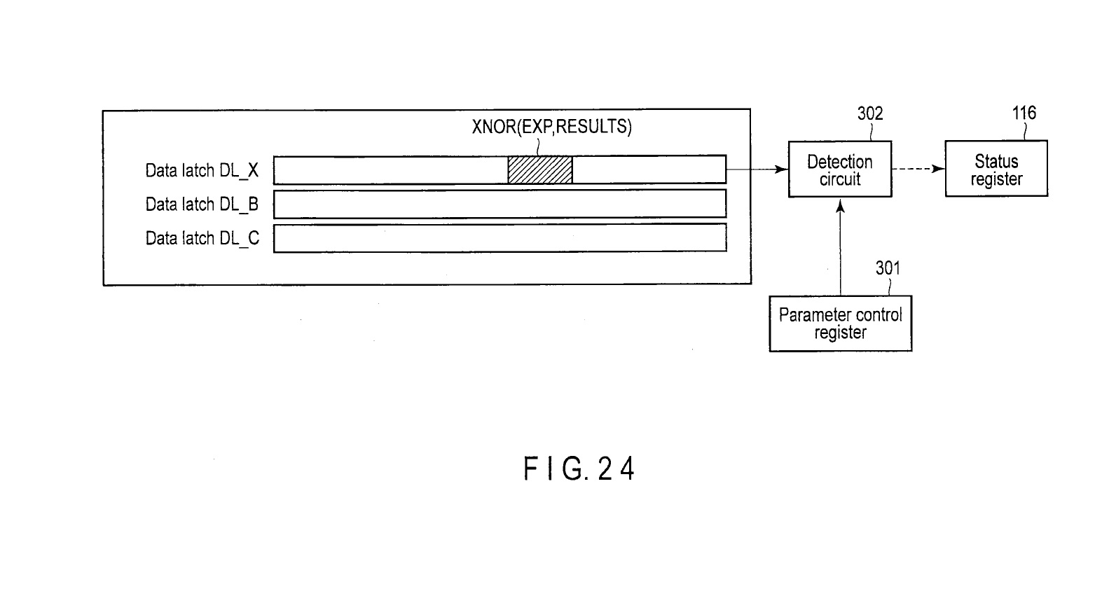

Next, the test device 201 supplies to the NAND chip 10 a reference value used to determine a pass or a fail in a detection operation performed in step S34 described later. The reference value is held in, for example, a parameter control register 301 shown in FIG. 24. The parameter control register 301 is provided in, for example, the logic control circuit 120 shown in FIG. 6.

[Step S23]

To make valid a command input related to security authentication, the test device 201 issues a command (ASC) in an authentication sequence mode and supplies the command to the NAND chip 10.

[Step S24]

Next, a specified expected value EXP is read from the ROM area 11-2.

Specifically, as shown in FIG. 18, the test device 201 issues command “29h,” two cycles of dummy addresses, a slot number (SLT), two cycles of dummy addresses, a data type “FFh” of FIG. 4, and a read executable command “30h” in that order.

As shown in FIG. 19, the NAND chip 10 reads an expected value EXP_i corresponding to the slot number from the ROM area 11-2 according to the executable command “30h” and transfers the expected value to a data latch DL_C.

Here, after the read operation has been completed, all the addresses excluding the address in which the expected value EXP_i in the data latch DL_C has been held are reset to zero.

[Step S25]

Thereafter, the test device 201 issues a reset command “FFh,” causing the NAND chip 10 to exit from the mode in which a security authentication operation is enabled.

[Step S26]

Since the reset command in step S25 also disables the test mode, the test device 201 issues an entry command TEC in the test mode again as in step S21 and supplies the command to the NAND chip 10.

[Step S27]

In this state, data is transferred and the expected value EXP_i held in the data latch DL_C is transferred to the data latch DL_B as shown in FIG. 19.

[Step S28]

As in step S23, the test device 201 issues an authentication sequence mode command ASC again and supplies the command to the NAND chip 10.

[Step S29]

Next, the test device 201 issues commands “91h,” “80h” indicating an authentication sequence, a slot number (SLT), two cycles of dummy addresses, a message Din “FF,” and an executable command “10h” in that order. The NAND chip 10 implements an authentication sequence according to the executable command “10h.”

Specifically, as shown in FIG. 20, secret key data KEY corresponding to the specified slot number is read from the hidden area 11-1 of the NAND chip 10 into the data latch DL_X.

In addition, message data MSG output from the test device 201 is held in a part of the data latch DL_X. The AES arithmetic circuit 17 of the NAND chip 10 carries out an authentication operation using the data latch DL_X as a RAM on the basis of the secret key data KEY and message data MSG.

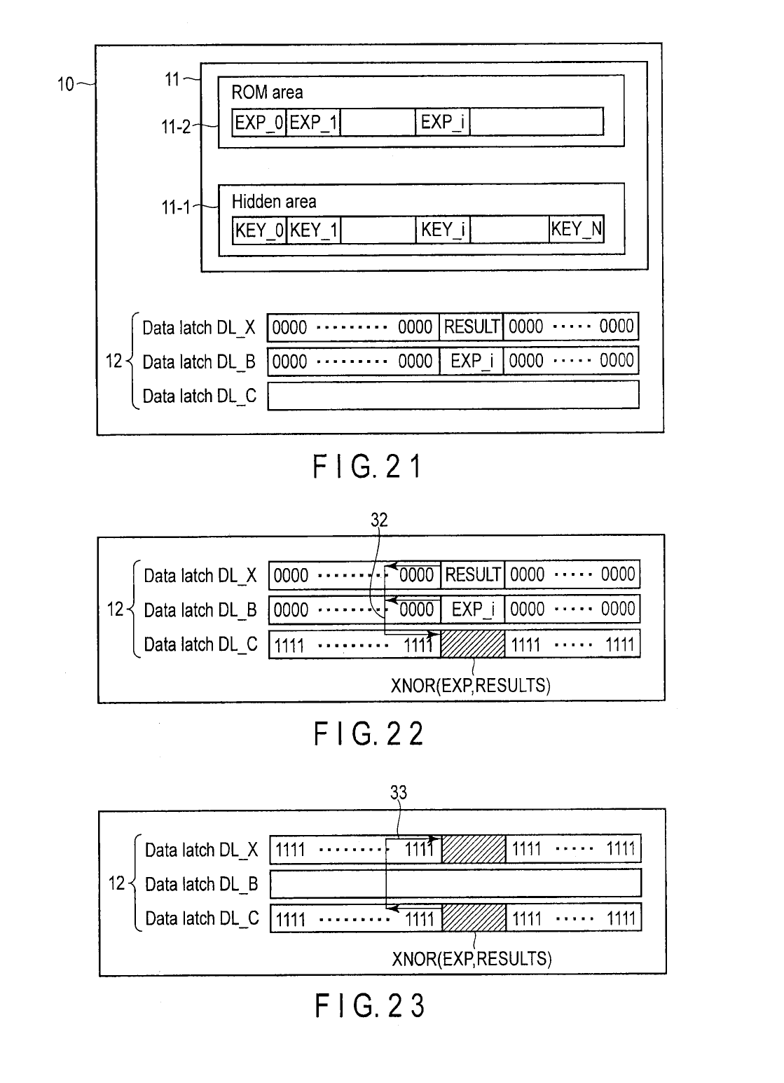

As shown in FIG. 21, when the authentication operation has been completed and the ready/busy signal has returned to the ready state, the operation result RESULT is held in the data latch DL_X. All the addresses excluding the address in which the operation result RESULT in the data latch DL_X has been held are reset to zero.

[Step S30]

Thereafter, the test device 201 issues a reset command “FFh,” causing the NAND chip 10 to exit from the authentication sequence mode.

[Step S31]

Since the reset command in step S30 also disables the test mode, the test device 201 issues an entry command TEC in the test mode again as in steps S21, S26 and supplies the command to the NAND chip 10.

[Step S32]

As shown in FIG. 22, responding to the entry command TEC, the operation result held in the data latch DL_X is XNORed (exclusive NORed) with the expected value EXP_i held in the data latch DL_B bit by bit. The result is stored in the data latch DL_C.

In the XNOR operation of the data latch DL_X and the data latch DL_B, if the data in the data latch DL_X coincides with that in the data latch DL_B, this gives “1.” If not, this gives “0.” In the data latch DL_X, a value other than the operation result RESULT is reset to zero. In the data latch DL_B, a value other than the expected value EXP_i is reset to zero. Therefore, the parts excluding the operation result RESULT and EXP_i all become “1” as a result of an XNOR operation.

[Step S33]

After this, as shown in FIG. 23, the result in step S32 held in the data latch DL_C is transferred to the data latch DL_X.

[Step S34]

Next, as shown in FIG. 24, the data held in the data latch DL_X is compared with the reference value held in the parameter control register 301 in step S22. The comparison is made by, for example, a detection circuit 302. The detection circuit 302 is provided in, for example, the arithmetic module 132 shown in FIG. 6. The detection circuit 302 counts the number of “0” bits in the data held in the data latch DL_X and compares the count with the reference value held in the parameter control register 301.

Specifically, the number of “0” bits in the data held in the data latch DL_X is compared with the reference value. For example, when the reference value (the number of bits) is two, if the number of “0” bits in the data held in the data latch DL_X is two or less, it is determined that the comparison has passed. If the number is three or more, it is determined that the comparison has failed. The determination result is held in the status register 116 by way of the logic control circuit 120.

[Step S35]

After this, when the test device 201 has issued status read command “70h,” the determination result held in the status register 116 is output as status data to the test device 201. On the basis of the status data, the test device 201 can determine whether a defect has occurred in the secret key data specified by the slot number.

### Effects of the Second Embodiment

With the second embodiment, the test device 201 has only to supply a test-mode entry command and the reference value to the NAND chip 10 and issue an authentication-sequence-mode command and an authentication sequence of the secret key data KEY is implemented in the NAND chip 10. Therefore, the NAND chip 10 can carry out a BIST.

In addition, the test device 201 can obtain the determination result of an authentication sequence from the NAND chip 10 by issuing a status read command. Therefore, the test device 201 need not carry out an authentication operation, making it possible to simplify the configuration of the test device 201.

In the first and second embodiments, as shown by (A) in FIG. 2, like secret key data KEY and encryption key data EKEY, expected values stored in each slot of the ROM area 11-2 may be in complementary form and in the form of a plurality of sets (EXP_i-0, bEXP_i-0)(EXP_i-1, bEXP_i-1)(EXP_i-n, bEXP_i-n) (b representing inverted data).

With this configuration, when having detected an error in reading an expected value to the outside, the data check circuit 113 can read another set in the same slot and check whether there is any error. If there is no error, the data check circuit 113 can output the expected value to the outside. This enables the reliability of the expected value to be increased.

In the first and second embodiments, the NAND chip 10 or the NAND chip 10 and controller 19 may constitute, for example, a memory card. In this case, the host devices 20, 200 and test device 201 can verify a defect in secret key data stored in the memory card in the same manner as in the first and second embodiments.

(Access Control of a Hidden Area)

As described above, the hidden area 11-1 is inhibited from being written into and read from.

However, it is necessary to write secret key data KEY into the hidden area 11-1. Therefore, the hidden area 11-1 can be written into and read from until secret key data KEY has been written. After the secret key data KEY has been written, the hidden area 11-1 is controlled so as to be inhibited from being written into and read from.

The hidden area 11-1 holds the secret key data KEY. Therefore, a device outside the NAND chip 10 cannot access the hidden area 11-1. For this reason, a device outside the NAND chip 10 cannot know the address of the hidden area 11-1 in the range of legitimate use.

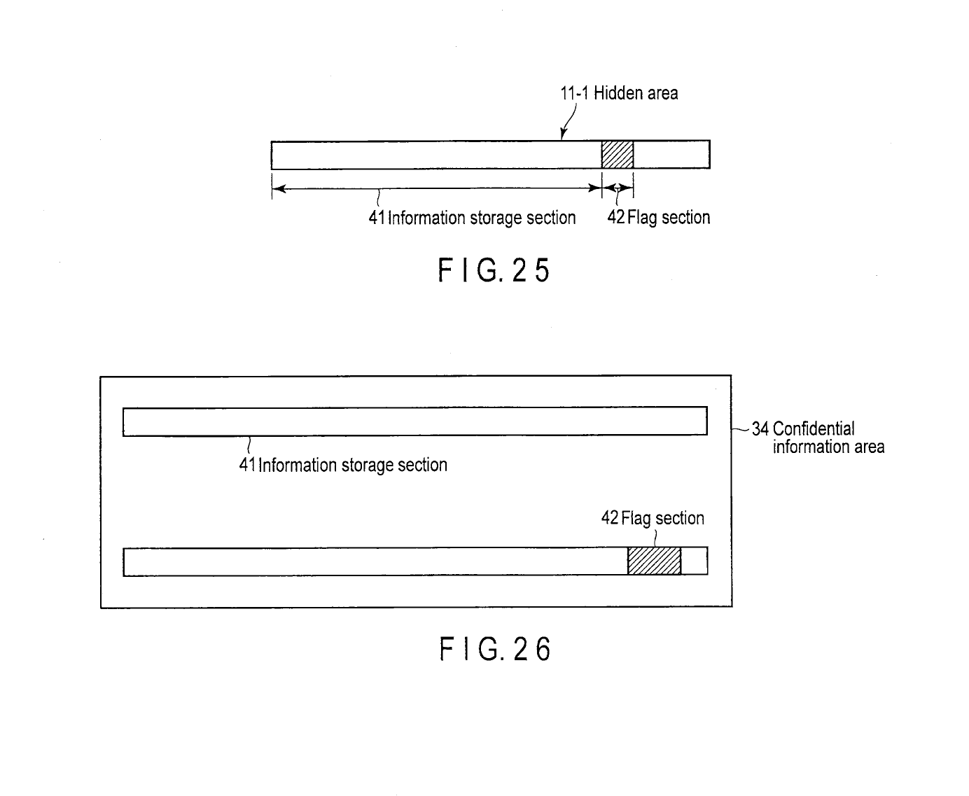

FIG. 25 shows an example of the structure of the hidden area 11-1. The hidden area 11-1 may include one or more pages or one or more blocks. As shown in FIG. 25, the hidden area 11-1 includes, for example, an information storage section 41 that stores secret key data KEY and a flag section 42. Specifically, a page or a block that constitutes the hidden area 11-1 includes a memory cell that holds data held in the information storage section 41 and a memory cell that holds data held in the flag section 42. The flag section 42 may be provided on a page differing from a page that holds confidential information.

For example, as shown in FIG. 26, the flag section 42 may be set on a page differing from a page serving as the information storage section 41 in the hidden area 11-1.

Each of the information storage section 41 and flag section 42 is composed of one or more bits. When the NAND chip 10 is configured to be capable of holding two or more bits of data in a memory cell, the hidden area 11-1 may hold one bit of data per cell or two or more bits of data per cell. However, it is desirable to hold one bit of data per cell because the reliability of data retention is higher and confidential information is required to have a higher reliability.

The information storage section 41 holds secret key data KEY as confidential information. When the hidden area 11-1 includes two or more pages, the flag section 42 may be provided on each of all the pages or on only a part of the pages. In the flag section 42, one or more bits of a specific pattern are written. When the specific bits have been written in the flag section 42, it is determined that the flag is valid. The position of the flag section 42 can be recognized by the address control module 123. Specifically, the flag section 42 is positioned, for example, at the end of each page or immediately after the information storage section 41 of the last one of a plurality of pages constituting the hidden area 11-1. Data in the flag section 42 is configured to be capable of being read into the logic control module 120 via the page buffer 133. That is, the address control module 123 is configured to be capable of grasping the addresses of the hidden area 11-1 including the flag section 42 and controlling various parts of the NAND chip 10 so as to read secret key data KEY into the logic control circuit 120.

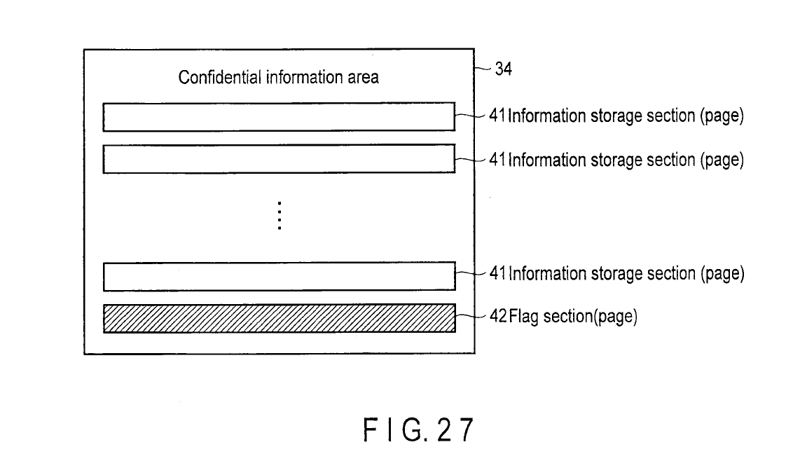

FIG. 27 shows another example of the hidden area 11-1. As shown in FIG. 27, the information storage section 41 and flag section 42 are stored in different pages (that is, since a page is allocated on a word line basis in the case of cells that hold one bit per cell, the information storage section 41 and flag section 42 are allocated to different word lines). A page including the flag section 42 does not hold confidential information. Data for a flag (flag data) is stored in a part of or in all the bits of a page for the flag section 42.

The AES encryption circuit 122 acting as an authentication circuit needs secret key data in an authentication process. To acquire secret key data, the AES encryption circuit 122 asks the address control circuit 123 to read secret key data.

The flag is written into at the same time that secret key data is written into the hidden area 11-1 or after that and until before the shipment of the NAND chip 10.

That is, in step S2 shown in FIG. 3, when a test is run by actually writing and erasing data into and from the hidden area 11-1, it is necessary to determine whether a flag has been written in the area. Only when the flag is invalid, the hidden area 11-1 is permitted to be written into and erased from. Flag determination will be described in detail later in step S3. In a test process, a voltage is trimmed and a parameter is written into a ROM fuse area 33. Next, secret key data is written into the hidden area 11-1 (step S3).

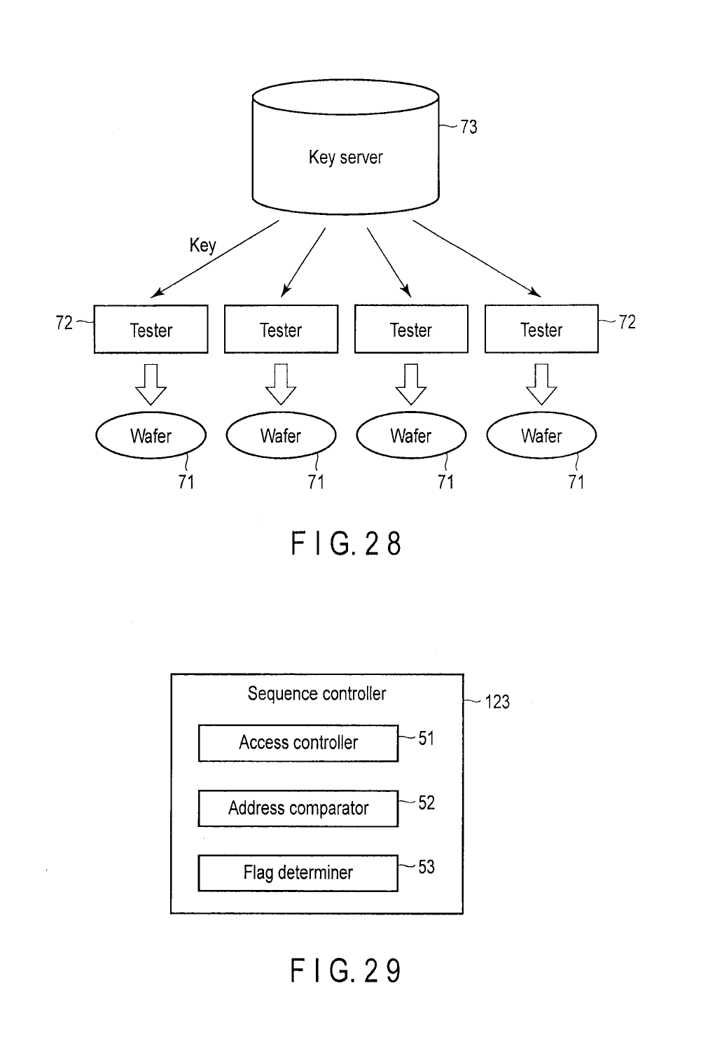

Secret key data is written using, for example, a system of FIG. 28.

FIG. 28 shows a secret key data write system applied to the first and second embodiments.

As shown in FIG. 28, a tester 72 for each wafer 71 receives secret key data from a key server 73. Secret key data differs from one chip to another. The tester 72 is connected to the key server 73 via, for example, the Internet, so as to be capable of communicating with the key server 73. The tester 72 writes the received secret key data into each hidden area 11-1 in the corresponding wafer 71.

When secret key data and a flag have been allocated to the same page, the flag is also written into the flag section 42 in the hidden area 11-1 at the same time that the secret key data is written since the NAND chip 10 is typically configured to be written into on a page basis. However, since simultaneous writing has nothing to do with the substance of the embodiment, the flag can be written at any time if it is at least after the writing of the secret key data and before the shipment of the NAND chip 10.

When the hidden area 11-1 has been configured as shown in FIG. 27, the process in step S3 is performed as follows. First, it is determined whether a flag has been written. If a flag has already been written, step S3 is terminated. If a flag has not been written, secret key data is written into the hidden area 11-1. Then, a flag is written and it is determined whether the flag has been written correctly. If the flag has not been written correctly, the hidden area 11-1 (typically a block for the hidden area 11-1) is erased and secret key data and a flag are written and a determination is made.

Then, the NAND chip 10 is shipped (step S4).

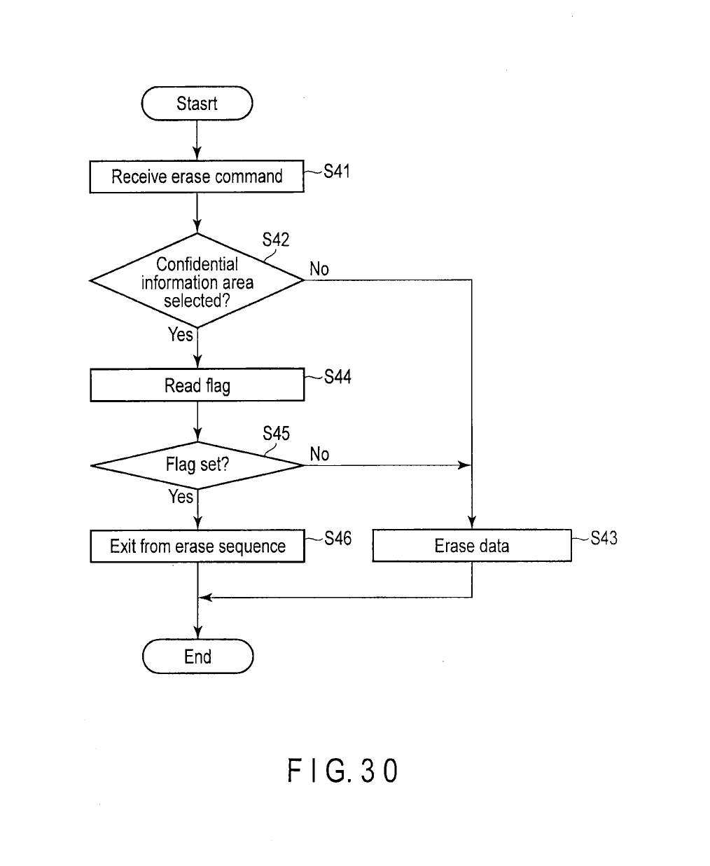

Next, a data erase sequence in the NAND chip 10 according to the first and second embodiments will be explained with reference to FIGS. 29 and 30.

FIG. 29 is a block diagram illustrating the details of the address control circuit 123. As shown in FIG. 29, the address control circuit 123 includes an access controller 51, an address comparator 52, and a flag determiner 53.

FIG. 30 is a flowchart to explain a data erase sequence in the NAND chip 10 according to the first and second embodiments.

As shown in FIG. 30, the address control circuit 123 receives an erase command (step S41).

The address comparator 52 compares a data erase object address related to the erase command with the address of the hidden area 11-1, determining whether the hidden area 11-1 has been selected (step S42).

It is assumed in the range of normal use after the shipment of the NAND chip 10 that the secret key data in the hidden area 11-1 is used only in an authentication operation in the NAND chip 10, whereas it is not assumed that the secret key data is erased. Such erasure is inhibited. In addition, the reading of the secret key data is started at the request of the authentication circuit 25 as a part of authentication. It is not assumed that the hidden area 11-1 is directly specified from outside the NAND chip 10. Therefore, it is not intended that the address of the hidden area 11-1 should be released to the public. Therefore, the hidden area 11-1 will not become an object of data erasure in the range of normal use after shipment and the comparison result from the address comparator 52 has shown that the addresses do not coincide with each other. If the addresses do not coincide with each other, the flow proceeds to step S43.

In step S43, the access control module 51 controls a related element, thereby erasing data in a specified address. The access controller 51 has the function of controlling a related element of the NAND chip 10 so as to write data into a specified address or erase or read data in a specified address. Then, after step S43, the data erasure is completed.

If the address of the hidden area 11-1 should have been leaked to outsiders through an illegal procedure, it is conceivable that an attacker that has known the address of the hidden area 11-1 tries to erase and update the secret key data in some way differing from a normal one and gives an instruction to erase data in the hidden area 11-1. When such an instruction has been received by the address control circuit 123, the determination in step S42 made by the address comparator 52 has shown YES. Having received this result, the access controller 51 transfers the flag to, for example, a latch (not shown) in the address control circuit 133 (step S44).

Next, the flag determiner 53 determines whether the flag is up (step S45). If the flag is down, the flag determiner 53 outputs a signal to that effect and proceeds to a process in step S43. A situation where the flag is down typically occurs in a test process (in step S2 of FIG. 3) before the writing of the secret key data KEY. In step S43, the access controller 51 erases data. In this way, a data erase test on the hidden area 11-1 can be performed.

When an erase sequence is implemented after the shipment of the NAND chip 10, the flag should be up. The address comparator 52 outputs this flag signal. Having received the signal, the access controller 51 skips an erase sequence of data in the specified address (step S46), that is, does not erase data in the specified address, terminating the erase sequence. That is, the access controller 51 aborts the process requested by the erase command. In this way, after the secret key data has been written, the secret key data cannot be erased.

When data in an area other than the hidden area 11-1 has been erased in an erase sequence as described above after the shipment, a busy signal is output to the outside during a period from when a command is received in step S41 until the erase sequence has been completed after data erasure in step S43. As described above, a low and a high ready/busy signal indicate a busy state and a ready state of, for example, the NAND chip 10, respectively. In addition, when the hidden area 11-1 has been accessed, an erase sequence is skipped without going through data erasure in step S43.

The erase operation on the hidden area 11-1 has been explained. The same holds true for a write operation or a read operation on the hidden area 11-1.

For example, before a flag is set, the hidden area 11-1 can be written into in a write operation. After a flag is set, the hidden area 11-1 is inhibited from being written into. Specifically, when data is written, a data write process is performed in step S43 shown in FIG. 30. Before secret key data KEY is written into the hidden area 11-1, a flag has not been written. Therefore, the determination result in step S45 has shown “NO.” In step S45, secret key data KEY is written into the hidden area 11-1. At the same time, or after the secret key data KEY has been written, a flag is written. In this way, when a flag has been written, if an attempt is made to write data into the NAND chip, the determination result in step S45 has shown “YES,” with the result that control is not passed to a write operation in step S43 and skips the write sequence.

Furthermore, for example, before a flag is set, the hidden area 11-1 can be read from in a read operation. After a flag is set, the hidden area 11-1 is inhibited from being read from. Specifically, when data is read, a data read process is performed in step S43 shown in FIG. 30. Before a flag is written, the determination result in step S45 has shown “NO.” Therefore, in step S43, a read process can be performed. When a flag has been written, if an attempt is made to read data from the NAND chip, the determination result in step S45 has shown “YES,” with the result that control is not passed to a read operation in step S43 and skips the read sequence.

As described above, when the flag has been set, the hidden area 11-1 is inhibited from being written into, read from, or erased from, which makes it difficult to access the secret key data from the outside.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory device comprising:
a memory cell array which includes a first storage area and a second storage area, the first storage area storing secret key data and being inhibited from being written into and read from, and the second storage area being inhibited from being written into and permitted to be read from and storing encrypted key data and an expected value; and
an encryption arithmetic module which carries out an authentication operation based on the secret key data stored in the first storage area and message data externally supplied, the expected values stored in the second storage area being the result of carrying out the authentication operation on the secret key data based on a specific message.

2. The device according to claim 1, wherein the expected values stored in the second storage area is read when a defect in the secret key data stored in the first storage area is verified.

3. The device according to claim 1, wherein the first storage area stores a plurality of secret key data items, and
the second storage area stores a plurality of key data items and expected values.

4. The device according to claim 3, further comprising:
a plurality of slots which are set in the first storage area and the second storage area and each of which includes one of the secret key data items, the key data items, and the expected values.

5. The device according to claim 4, wherein the expected values are provided in the form of a plurality of sets in complementary form.

6. The device according to claim 1, further comprising,
a host device,
wherein the host device reads the expected value stored in the second storage area when a defect has occurred in the nonvolatile semiconductor memory device, supplies the specific message to the encryption arithmetic module, and causes the encryption arithmetic module to compare the result of carrying out the authentication operation on the secret key data stored in the first storage area with the expected value based on the specific message.

7. A nonvolatile semiconductor memory device comprising:
a memory cell array which includes a first storage area and a second storage area, the first storage area storing secret key data and being inhibited from being written into and read from, and the second storage area being inhibited from being written into and permitted to be read from and storing encrypted key data and an expected value;
an encryption arithmetic module which carries out an authentication operation based on the secret key data stored in the first storage area and message data externally supplied, the expected value stored in the second storage area being the result of carrying out the authentication operation on the secret key data based on a specific message;
a storage module which stores a reference value;
a detection module which detects the passing or failing of the authentication operation result from the encryption arithmetic module based on the reference value stored in the storage module and which outputs status data indicating the passing or failing; and
a register which holds the status data output from the detection module.

8. The device according to claim 7, wherein the first storage area stores a plurality of secret key data items, and
the second storage area stores a plurality of key data items and expected values.

9. The device according to claim 8, further comprising:
a plurality of slots which are set in the first storage area and the second storage area and each of which includes one of the secret key data items, the key data items, and the expected values.

10. The device according to claim 9, wherein the expected values are provided in the form of a plurality of sets in complementary form.

11. The device according to claim 7, further comprising,
a host device,
wherein the host device supplies the reference value to the nonvolatile semiconductor memory device when a defect has occurred in the nonvolatile semiconductor memory device,
issues a first command to carry out the authentication operation, and
issues a second command to read the status data held in the register.

12. A memory system comprising:
a nonvolatile semiconductor memory device; and
a host device,
the nonvolatile semiconductor memory device comprising:
a memory cell array which includes a first storage area and a second storage area, the first storage area storing secret key data and being inhibited from being written into and read from, and the second storage area being inhibited from being written into and permitted to be read from and storing encrypted key data and an expected value; and
an encryption arithmetic module which carries out an authentication operation based on the secret key data stored in the first storage area and message data externally supplied, the expected value stored in the second storage area being the result of carrying out the authentication operation on the secret key data based on a specific message, and
the host device reads an expected value stored in the second storage area when a defect has occurred in the nonvolatile semiconductor memory device, supplies the specific message to the encryption arithmetic module, and causes the encryption arithmetic module to compare the result of carrying out the authentication operation on the secret key data stored in the first storage area with the expected value based on the specific message.

13. The system according to claim 12, wherein the expected value stored in the second storage area is read when a defect in the secret key data stored in the first storage area is verified.

14. The system according to claim 13, wherein the first storage area stores a plurality of secret key data items, and
the second storage area stores a plurality of key data items and expected values.

15. The system according to claim 14, further comprising:
a plurality of slots which are set in the first storage area and the second storage area and each of which includes one of the secret key data items, the key data items, and the expected values.

16. The system according to claim 15, wherein the expected values are provided in the form of a plurality of sets in complementary form.

17. A memory system comprising:
a nonvolatile semiconductor memory device; and
a host device,
the nonvolatile semiconductor memory device comprising:
a memory cell array which includes a first storage area and a second storage area, the first storage area storing secret key data and being inhibited from being written into and read from, and the second storage area being inhibited from being written into and permitted to be read from and storing encrypted key data and an expected value;
an encryption arithmetic module which carries out an authentication operation based on the secret key data stored in the first storage area and message data externally supplied, the expected value stored in the second storage area being the result of carrying out the authentication operation on the secret key data based on a specific message;
a storage module which stores a reference value;
a detection module which detects the passing or failing of the authentication operation result from the encryption arithmetic module based on the reference value stored in the storage module and which outputs status data indicating the passing or failing; and
a register which holds the status data output from the detection module, and
the host device supplies the reference value to the nonvolatile semiconductor memory device when a defect has occurred in the nonvolatile semiconductor memory device, issues a first command to carry out the authentication operation, and issues a second command to read the status data held in the register.

18. The system according to claim 17, wherein the first storage area stores a plurality of secret key data items, and
the second storage area stores a plurality of key data items and expected values.

19. The system according to claim 18, further comprising:
a plurality of slots which are set in the first storage area and the second storage area and each of which includes one of the secret key data items, the key data items, and the expected values.

20. The system according to claim 19, wherein the expected values are provided in the form of a plurality of sets in complementary form.
